(19) United States
(12) Patent Application Publication
(10) Pub. No.: US 2017/0251169 A1
(43) Pub. Date: Aug. 31, 2017

(54) APPARATUS AND METHODS FOR CONTEXT BASED VIDEO DATA COMPRESSION

(71) Applicant: GoPro, Inc., San Mateo, CA (US)

(72) Inventors: Philip Meier, San Diego, CA (US); Vadim Polonichko, San Diego, CA (US)

(21) Appl. No.: 14/332,331

(22) Filed: Jul. 15, 2014

Related U.S. Application Data
(60) Provisional application No. 62/007,311, filed on Jun. 3, 2014.

(51) Int. Cl. H04N 7/01; H04N 5/77; G06K 9/32; H04N 5/232; H04N 7/18

(52) U.S. Cl. CPC H04N 7/0127; H04N 5/23203; H04N 7/188; G06K 9/3241; G06K 9/3208; H04N 5/77

(57) ABSTRACT

In some implementations, a camera may be disposed on an autonomous aerial platform. A user may operate a smart wearable device adapted to configured, and/or operate video data acquisition by the camera. The camera may be configured to produce a time stamp, and/or a video snippet based on receipt of an indication of interest from the user. The aerial platform may comprise a controller configured to navigate a target trajectory space. In some implementation, a data acquisition system may enable the user to obtain video footage of the user performing an action from the platform circling around the user.

### CROSS-REFERENCE TO RELATED APPLICATIONS

This application claims the priority benefit of U.S. Provisional Patent Application Ser. No. 62/007,311 filed on Jun. 3, 2014 and entitled “APPARATUS AND METHODS FOR TRACKING USING AERIAL VIDEO”; and is related to co-owned and co-pending U.S. patent application Ser. No. XXX, Client Reference BC201413A, Attorney Docket No. 021672-0432604 filed on Jul. 15, 2014 herewith, and entitled “APPARATUS AND METHODS FOR TRACKING USING AERIAL VIDEO”, U.S. patent application Ser. No. XXX, Client Reference BC201415A, Attorney Docket No. 021672-0433333 filed on Jul. 15, 2014 herewith, and entitled “APPARATUS AND METHODS FOR AERIAL VIDEO ACQUISITION”, U.S. patent application Ser. No. 13/601,721 filed on Aug. 31, 2012 and entitled “APPARATUS AND METHODS FOR CONTROLLING ATTENTION OF A ROBOT” and U.S. patent application Ser. No. 13/601,827 filed Aug. 31, 2012 and entitled “APPARATUS AND METHODS FOR ROBOTIC LEARNING”, each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Field of the Disclosure

The present disclosure relates to apparatus and methods for tracking human subjects, and/or other moving and/or static objects using aerial video data.

Description of Related Art

Aerial unmanned vehicles may be used for collecting live video data. A programming and/or two way communication between the remote vehicle and a user may be employed in order to control video collection. Users engaged in attention consuming activities (e.g., surfing, biking, skateboarding, and/or other activities) may not be able to control remote devices with sufficient speed and/or accuracy using conventional remote control devices and/or pre-programmed trajectories.

### SUMMARY

One aspect of the disclosure relates to a method of context based video acquisition by an autonomous mobile camera apparatus. The method may comprise one or more of acquiring video of a visual scene at a first data rate using the mobile camera apparatus; producing lower rate video from the video, the lower rate video characterized by a lower data rate compared to the first data rate; transmitting the lower data rate video via a wireless communications interface; detecting an indication of interest associated with the video scene; in response to detection of the indication, storing the video at the camera apparatus at the first data rate, and/or other operations.

One aspect of the disclosure relates to a mobile camera apparatus. The mobile camera apparatus may include one or more of a camera sensor, a circular memory buffer, a nonvolatile storage, a communications interface, a processing component, and/or other components. The camera sensor may be configured to provide video at a full data rate. The circular memory buffer may be configured to store a portion of the video at the full data rate, the portion characterized by a first duration. The nonvolatile storage may be configured to store video at a reduced data rate for a second duration, the second duration being greater than the first duration. The communications interface may be configured to detect indications of interest associated with the video being acquired. The processing component may be configured to produce and store video snippets in response the detected indications of interest by, based on an individual indication of interest: produce a video snippet, the video snippet characterized by the full resolution, the video snippet production comprising transferring the portion of video at the full resolution from the buffer to the nonvolatile storage; and store a time tag in a table in the nonvolatile storage, the tag associated with the video snippet. The nonvolatile storage may be configured to store video at the full data rate for a third duration, the third duration being greater than the first duration and smaller than the second duration. Producing the video snippets may enable the mobile camera apparatus to obtain video at the full resolution over a time period of at least the second duration.

One aspect of the disclosure relates to a mobile video acquisition apparatus. The video acquisition apparatus may include one or more of a camera component, a nonvolatile storage, a communications interface, a logic, and/or other components. The camera component may be configured to provide video of a user. The nonvolatile storage may be capable of storing the video for a first duration. The communications interface may be configured to detect an indication of interest of a plurality of indication of interest associated with the video being provided. The logic may be configured to produce times stamps in response to detected indications of interest by, based on an individual indication of interest, produce a time stamp. The individual indication of interest may be produced by a user wearable device based on an action of the user, the wearable device disposed remote from the video acquisition apparatus and in data communication with the video acquisition apparatus. The individual time stamp may enable automatic access to a respective video snippet of the video stored on the nonvolatile storage corresponding to the individual indication of interest. The respective snippet may be of a snippet duration. The combined duration of snippet durations for video snippets may correspond to the detected indications of interest is smaller than the first duration.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a graphical illustration depicting an autonomous aerial device configured to follow a person using real time video, according to some implementations.

FIG. 2 is an illustration depicting exemplary trajectory configuration useful for video collection by an autonomous aerial vehicle of, e.g., FIG. 1, according to some implementations.

FIG. 3A is an illustration depicting exemplary trajectories of the autonomous aerial vehicle of FIG. 1 during tracking of a subject of interest (SOI), according to some implementations.

FIG. 3B is an illustration depicting exemplary trajectories of the autonomous aerial vehicle of FIG. 3A in presence of obstacles during tracking of an SOI, according to some implementations.

FIG. 3C is an illustration depicting exemplary trajectory of the autonomous aerial vehicle of FIG. 3A configured to populate allowable state space in presence of obstacles during tracking of an SOI, according to some implementations.

FIGS. 4A-4D illustrate various exemplary devices useful for communicating with autonomous aerial vehicles (e.g., of FIGS. 1, 3A, 8A) during tracking and/or video collection, according to some implementations.

FIG. 5A depicts configuration of uniform length video snippets obtained based on user indication for use with video acquisition by the aerial vehicle of FIG. 1, according to some implementations.

FIG. 5B depicts configuration of non-uniform length video snippets obtained based on user indication for use with video acquisition by the aerial vehicle of FIG. 1, according to some implementations.

FIG. 5C depicts configuring pre/post event duration of a video snippet for use with video acquisition by the aerial vehicle of FIG. 1, according to some implementations.

FIG. 5D depicts multiple snippets produce responsive to multiple proximate indications of user interest for use with video acquisition by the aerial vehicle of FIG. 1, according to some implementations.

FIG. 5E depicts storing of video snippets in an array based on detection of one or more events provided to the aerial vehicle of FIG. 1 during video acquisition, according to some implementations.

FIG. 6 is a functional block diagram illustrating a computerized apparatus for implementing, inter alia, tracking, video acquisition and storage, motion and/or distance determination methodology in accordance with one or more implementations.

FIG. 7A is an illustration depicting exemplary use of a quad-rotor UAV for tracking a person carrying a wearable device, according to some implementations.

FIG. 7B is a block diagram illustrating sensor components of an UAV configured for tracking an SOI, according to some implementations.

FIG. 8A is an illustration depicting exemplary use of a quad-rotor UAV for tracking a bicyclist, according to some implementations.

FIG. 8B is a block diagram illustrating a smart grip interface to the UAV of FIG. 8A, according to some implementations.

FIG. 9A is a graphical illustration depicting tracking of a moving subject of interest using moving camera, according to some implementations.

FIG. 9B is a graphical illustration depicting adjustment of the UAV camera orientation when tracking a stationary subject of interest, according to some implementations.

FIGS. 10A, 10B, and 10C illustrate use of an umbrella UAV for tracking a SOI, according to some implementations.

FIGS. 11A-11B illustrate use of a vehicle-docked umbrella UAV for tracking a SOI, according to some implementations.

FIG. 12 is a functional block diagram illustrating a cloud server repository, according to some implementations.

FIG. 13A is a graphical illustration depicting an aerial platform comprising a camera, according to some implementations.

FIG. 13B is a graphical illustration depicting a system configured to manipulate a camera according to some implementations.

FIG. 13C is a plot depicting state space parameters useful for trajectory navigation by, e.g., the apparatus of FIG. 13A, according to some implementations.

FIG. 13D is a graphical illustration depicting a mobile camera apparatus, according to some implementations.

FIG. 14A is a logical flow diagram illustrating generalized method for trajectory control useful when acquiring video from a mobile camera device, in accordance with some implementations.

FIG. 14B is a logical flow diagram illustrating a method for producing a time stamp based on an indication of interest, in accordance with some implementations.

FIG. 14C is a logical flow diagram illustrating a method for producing a video snippet based on an indication of interest, in accordance with some implementations.

FIG. 14D is a logical flow diagram illustrating generalized method for operating a smart wearable device, in accordance with some implementations.

All Figures disclosed herein are © Copyright 2014 Brain Corporation. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation or implementation, but other implementations and implementations are possible by way of interchange of or combination with some or all of the described or illustrated elements. Wherever convenient, the same reference numbers will be used throughout the drawings to refer to same or like parts.

Where certain elements of these implementations can be partially or fully implemented using known components, only those portions of such known components that are necessary for an understanding of the present technology will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device “may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs), and/or other types of integrated circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.), IrDA families, and/or other network interfaces.

As used herein, the terms “node”, “neuron”, and “neuronal node” are meant to refer, without limitation, to a network unit (e.g., a spiking neuron and a set of synapses configured to provide input signals to the neuron) having parameters that are subject to adaptation in accordance with a model.

As used herein, the terms “state” and “node state” is meant generally to denote a full (or partial) set of dynamic variables used to describe node state.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

It may be desirable to utilize autonomous aerial vehicles for video data collection. A video collection system comprising an aerial (e.g., gliding, flying and/or hovering) vehicle equipped with a video camera and a control interface may enable a user to start, stop, and modify a video collection task (e.g., circle around an object, such as a person and/or a vehicle), as well as to indicate to the vehicle which instances in the video may be of greater interest than others and worth watching later. The control interface apparatus may comprise a button (hardware and/or virtual) that may cause generation of an indication of interest associated with the instance of interest to the user. The indication of interest may be communicated to a video acquisition apparatus (e.g., the aerial vehicle).

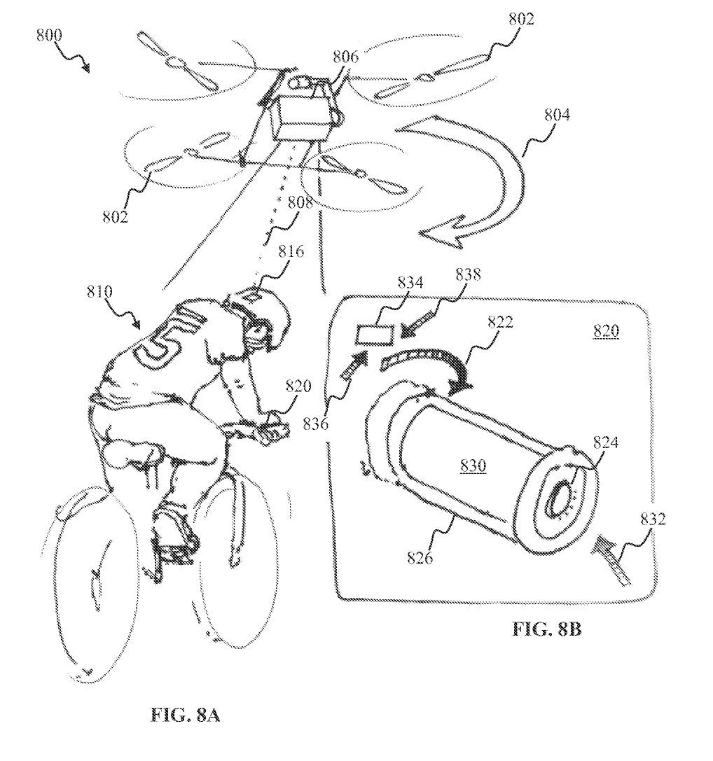

In one or more implementations, the video collection system may comprise a multi-rotor Unmanned Aerial Vehicle (UAV), e.g., such as illustrated and described with respect to FIGS. 1, 7A, 8A, 10A-11B, below. In some implementation, the interface apparatus may comprise a wearable apparatus such as, for example, a smart watch (e.g., Toq™), a clicker, smart glasses, a pendant, a key fob, and/or other mobile communications device (e.g., a phone, a tablet). In one or more implementations, the interface may comprise smart hand grip-like sports equipment, e.g., a smart bike handlebar described below with respect to FIG. 8B, a smart glove, a smart ski pole, a smart helmet, a smart show, and/or other computerized user device.

The interface apparatus may communicate to the UAV via a wireless communication channel (e.g., radio frequency, infrared, light, acoustic, and/or a combination thereof and/or other modalities).

By way of an illustration, a sports enthusiast may utilize the proposed video collection system to record footage of herself surfing, skiing, running, biking, and/or performing other activity. In some implementations, a home owner may use the system to collect footage of the leaves in the roof's gutter, roof conditions, survey not easily accessible portion of property (e.g., up/down a slope from the house) and/or for other needs. A soccer coach may use the system to collect footage of all the plays preceding a goal.

Prior to flight (also referred to as “pre-flight”) the user may configure flight trajectory parameters of the UAV (e.g., altitude, distance, rotational velocity, and/or other parameters), configure recording settings (e.g., 10 seconds before, 20 seconds after the indication of interest), the direction and/or parameters of rotation after a pause (e.g., clockwise, counter clock, alternating, speed). In one or more implementations, the user may load an operational profile (e.g., comprising the tracking parameters, target trajectory settings, video acquisition parameters, and/or environment metadata). As used herein the term video acquisition may be used to describe operations comprising capture (e.g., transduction is light to electrical signal volts) and buffering (e.g., retaining digital samples after an analog to digital conversion). Various buffer size and/or topology (e.g., double, triple buffering) may be used in different systems, with common applicable characteristics: buffers fill up; for a given buffer size, higher data rate may be achieved for shorter clip duration. Buffering operation may comprise producing information related to acquisition parameters, duration, data rate, time of occurrence, and/or other information related to the video.

The term video storage may be used to describe operations comprising persistent storing of acquired video (e.g., on flash, magnetic and/or other medium). Storing operations may be characterized by storage medium capacity greatly exceeding the buffer size. In some implementations, storage medium does not get depleted by subsequent capture events in a way that would hinder resolution of the capture process for, e.g., 0.005 second to 500 second clips. Storage may be performed using a local storage device (e.g., an SD card) and/or on a remote storage apparatus (e.g., a cloud server).

The pre-flight configuration may be performed using a dedicated interface apparatus and/or using other computerized user interface (UI) device. In some implementations, the user may employ a portable device (e.g., smartphone running an app), a computer (e.g., using a browser interface), wearable device (e.g., pressing a button on a smart watch and/or clicker remote and/or mode button on a smart hand-grip), and/or other user interface means.

The user may utilize the interface apparatus for flight initiation, selection of a subject of interest (SOI) (e.g., tracking target), calibration, and/or operation of the UAV data collection. In some implementations the SOI may be used to refer to a tracked object, a person, a vehicle, an animal, and/or other object and/or feature (e.g., a plume of smoke, extend of fire, wave, an atmospheric cloud, and/or other feature). The SOI may be selected using video streamed to a portable device (e.g., smartphone) from the UAV, may be detected using a wearable controller carried by the SOI and configured to broadcasts owners intent to be tracked, and/or other selection methods. In some implementations, a user may utilize a remote attention indication methodology described in, e.g., co-owned and co-pending U.S. patent application Ser. No. 13/601,721 filed on Aug. 31, 2012 and entitled “APPARATUS AND METHODS FOR CONTROLLING ATTENTION OF A ROBOT”, incorporated supra. As described in above-referenced application No. '721, attention of the UAV may be manipulated by use of a spot-light device illuminating a subject of interest. A sensor device disposed on the UAV may be used to detect the signal (e.g., visible light, infrared light), reflected by the illuminated area requiring attention. The attention guidance may be aided by way of an additional indication (e.g., sound, radio wave, and/or other) transmitted by an agent (e.g., a user) to the UAV indicating that the SOI has been illuminated. Responsive to detection of the additional indication, the UAV may initiate a search for the signal reflected by the illuminated area requiring its attention. Responsive to detecting the illuminated area the UAV may associate one or more objects within the area as the SOI for subsequent tracking and/or video acquisition. Such approach may be utilized, e.g., to indicate SOI disposed in hard to reach areas (e.g., underside of bridges/overpasses, windows in buildings and/or other areas.

FIG. 1 illustrates use of an autonomous aerial device configured to follow a subject of interest (SOI) using real time video, according to some implementations. The autonomous aerial device 100 of FIG. 1 may comprise a multi-rotor UAV (e.g., DJI Phantom, Draganflyer X6, Aibot X6, Parrot ASR Drone®, Hex) comprising a plurality of propellers 110 and a sensor component 104. Although methodology of the present disclosure is illustrated using rotor UAV devices it will be recognized by those skilled in the arts that methodologies described herein may be utilized with other devices such remote controlled planes, gliders, kites, balloons, blimps, model rockets, hybrids thereof, and/or practically any other aerial vehicles weighting less than 25 kg and with dimensions selected from the range between 0.5 m to 3 m.

In one or more implementations, the sensor component 104 may comprise one or more cameras configured to provide video information related to the person 106. The video information may comprise for example multiple streams of frames received from a plurality of cameras disposed separate from one another. Individual cameras may comprise an image sensor (e.g., charge-coupled device (CCD), CMOS device, and/or an active-pixel sensor (APS), photodiode arrays, and/or other sensors). In one or more implementations, the stream of frames may comprise a pixel stream downloaded from a file. An example of such a file may include a stream of two-dimensional matrices of red green blue RGB values (e.g., refreshed at a 12 Hz, 30 Hz, 60 Hz, 120 Hz, 250 Hz, 1000 Hz and/or other suitable rate). It will be appreciated by those skilled in the art when given this disclosure that the above-referenced image parameters are merely exemplary, and many other image representations (e.g., bitmap, luminance-chrominance (YUV, YCbCr), cyan-magenta-yellow and key (CMYK), grayscale, and/or other image representations) are equally applicable to and useful with the various aspects of the present disclosure. Furthermore, data frames corresponding to other (non-visual) signal modalities such as sonograms, infrared (IR), lidar, radar or tomography images may be equally compatible with the processing methodology of the disclosure, or yet other configurations.

The device 100 may be configured to move around the person 106 along, e.g., a circular trajectory denoted by arrow 102 in FIG. 1. The sensor component 104 may comprise one or more of Global Positioning System (GPS) receiver, proximity sensor, inertial sensors, long-base and/or short-base wireless positioning transceiver, wireless communications transceiver. Motion of the device 100 along the trajectory 102 may be determined using a variety of approaches including, e.g., evaluation and/or fusion of data from GPS position, velocity, inertial sensors, proximity sensors, long-base, short-base positioning, wireless localization, and/or other approaches. In some implementations, device 100 motion may be determined using video signal provided by one or more cameras of the sensor component 104 using, e.g., methodology described in U.S. patent application Ser. No. 14/285,385, entitled “APPARATUS AND METHODS FOR REAL TIME ESTIMATION OF DIFFERENTIAL MOTION IN LIVE VIDEO”, filed on May 22, 2014, the foregoing incorporated herein by reference in its entirety.

In some implementations wherein the sensor component comprises a plurality of cameras, the device 100 may comprise a hardware video encoder configured to encode interleaved video from the cameras using motion estimation encoder. Video information provided by the cameras may be used to determine direction and/or distance 108 to the person 106. The distance 108 determination may be performed using encoded interleaved video using, e.g., methodology described in co-pending and co-owned U.S. patent application Ser. Nos. 14/285,414, entitled “APPARATUS AND METHODS FOR DISTANCE ESTIMATION USING MULTIPLE IMAGE SENSORS”, filed on May 22, 2014, and/or 14/285,466, entitled “APPARATUS AND METHODS FOR ROBOTIC OPERATION USING VIDEO IMAGERY”, filed on May 22, 2014, each of the foregoing incorporated herein by reference in its entirety.

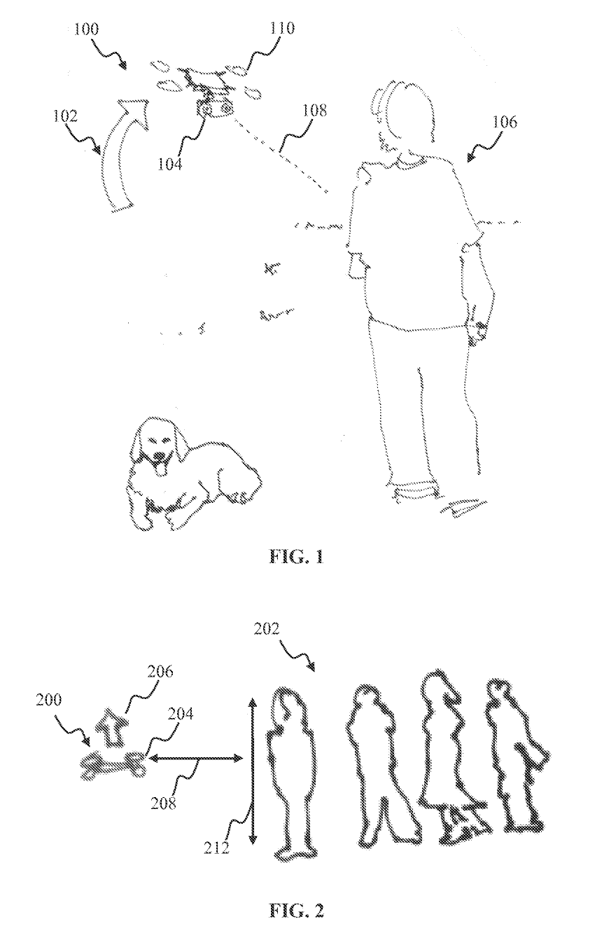

FIG. 2 illustrates exemplary trajectory configuration useful for video collection by an autonomous aerial vehicle of, e.g., FIG. 1, according to some implementations.

The aerial vehicle 200 of FIG. 2 may be configured to track one or more person within group 202 and record video thereof while visually and/or spatially avoiding the other people. The vehicle 200 may comprise an aerial platform, a multi-rotor UAV and/or other flying platform equipped with a video camera. The aerial platform may be configured to maintain minimum safe distance 208 form persons within the group 202. For video acquisition, the vehicle 200 may be configured to maintain a given height 212 above ground (e.g., eye-level). Upon determining that the current position of the vehicle 200 is outside the specified parameters (e.g., too close, too high, and/or too low) the vehicle 200 may automatically adjust its location, e.g., by moving up as shown by arrow 206 in FIG. 2. In some implementations, the position of the aerial platform may be determined by a user parameter controlling the rate of change of positional properties (e.g., a rate of angular rise with respect to the SOI, a rate of lateral velocity with respect to the SOI, maximal angular velocity with respect to a global external coordinate frame, maximal allowed image blur from motion, and/or other properties). In some embodiments, these controls may be selected by the user in preflight and/or determined by a default parameter configuration. In some embodiments control schemes may use parameters that minimize higher order moments of position, such as acceleration, jerk or snap. Vehicle trajectory and/or video data acquisition may be configured using any applicable methodologies described herein.

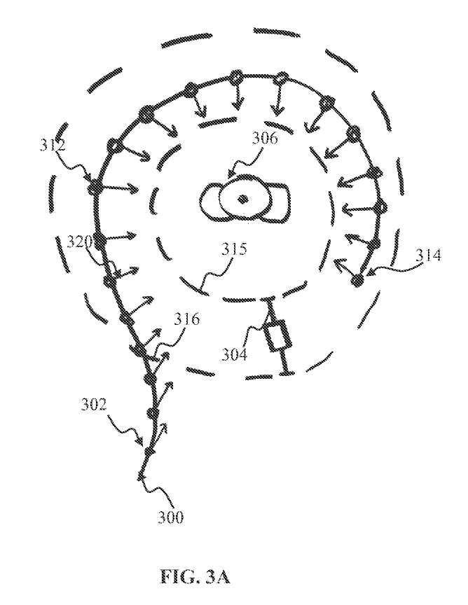

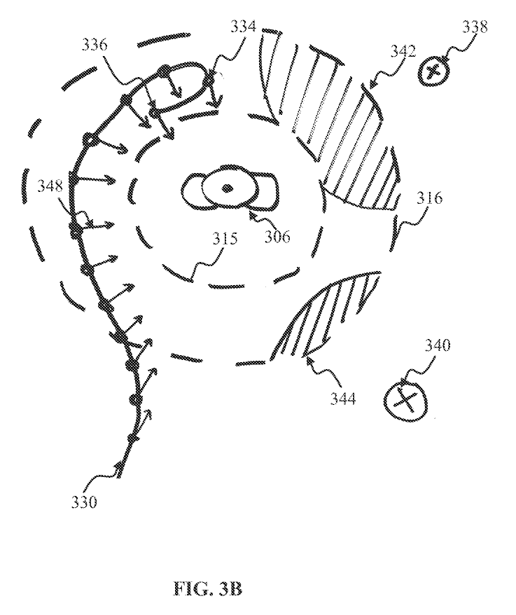

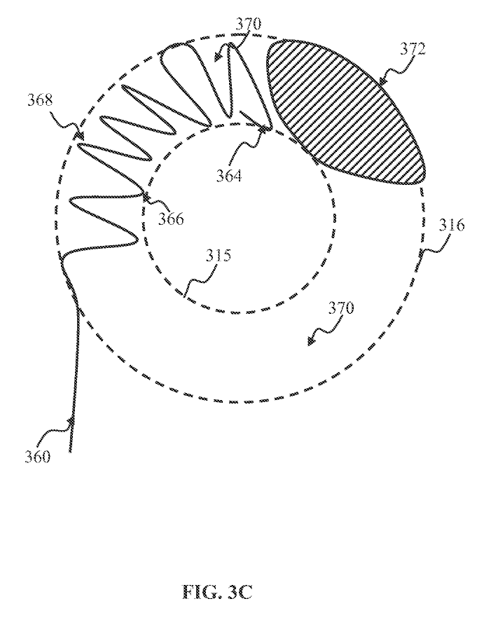

FIG. 3A illustrates exemplary trajectory of an UAV configured to obtain video of the SOI from multiple perspectives, according to some implementations. The aerial vehicle described with respect to FIG. 3A may comprise an aerial platform, for example, a multi-rotor UAV and/or other flying platform equipped with a video camera. The vehicle may be configured to navigate around the SOI that may be a person 306 while taking video. The vehicle trajectory may be characterized by one or more parameter constraints. In one or more implementations, the trajectory parameters may comprise height above ground (e.g., 208 in FIG. 2 above), minimum/maximum distance, denoted by broken line rings 315, 316 in FIG. 3A, from the SOI. The vehicle controller may be configured to maintain its radial range from the SOI 306 within range 304. In one or more implementations, the range extent 304 may be selected between a minimum distance from SOI of 0.5 m to maximum distance from SOI of 30 m. In some implementations, the range may be selected using a given inner range (e.g., a range of radii specified by properties of the target video footage, indicated by the box range, e.g., 3-4 meters) and an outer range (e.g., a range of radii imposed by safety, indicated by the whisker range and the radii 315, 316, e.g., 2-10 meters). The vehicle trajectory 300 may be characterized by one or more locations, e.g., 302, 312, 314 in FIG. 3A. At location 302, the vehicle controller may determine that the vehicle trajectory is outside the target range extent 304 from the SOI 306. The controller may instruct the vehicle to approach the SOI along the trajectory 300. When the vehicle is at location 312, the vehicle controller may adjust the vehicle trajectory to follow a curve around the SOI 306. Upon approaching the location 314 the controller may instruct the vehicle to stop video acquisition, land, recede from the SOI, perform another pass around the SOI, and/or perform other actions. Upon reaching location 314 the vehicle may continue flying in a trajectory determined by control policy that remains within the annular region between 315 and 316, yet continues to satisfy the users requested movement criteria (e.g., constraints imposed upon velocity, altitude, smoothness, minimized jerk, obtains a periodic rise, and/or other constraints), as long as the environment affords such behavior (e.g., no detected obstacles interfering with path) and/or no additional provides evidence for a criteria switch (e.g., upon detection of a user falling, platform lands, or hovers nearby overhead with a distress signal). While navigating the trajectory 300, the vehicle controller may maintain camera orientation pointing at the SOI, as indicated by arrows in FIG. 3A (e.g., arrow 320).

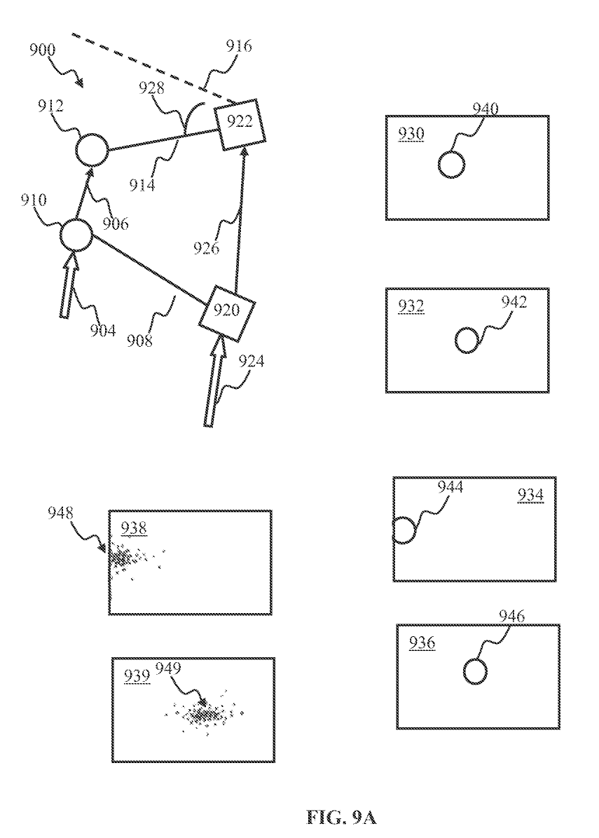

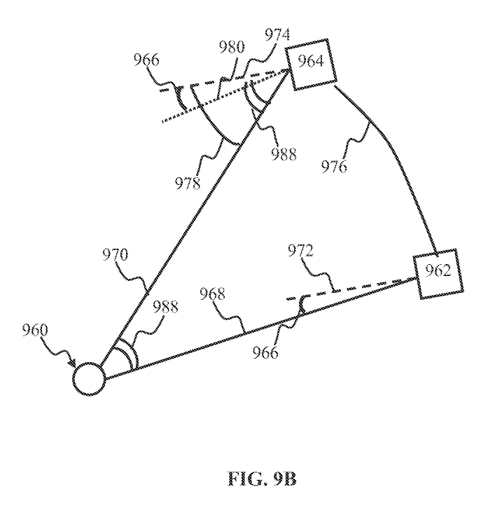

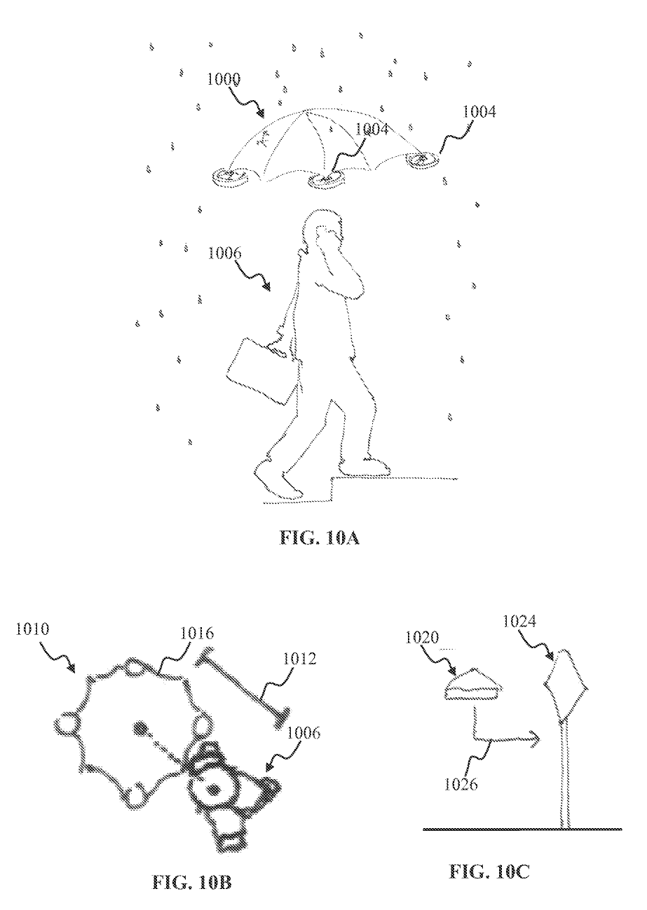

FIG. 3B illustrates exemplary trajectory of the autonomous aerial vehicle described above with respect to FIG. 3A in presence of obstacles during tracking of a SOI, according to some implementations. The trajectory 330 may be configured in accordance with the distance from the target constraints 316 described above with respect to FIG. 3A. The disc bounded by broken curves 316 in FIGS. 3A-3B may denote valid trajectory state space. When the SOI 306 in FIG. 3B is disposed proximate to one or more obstacles 340, 338 at least partly encroaching on the valid trajectory space. Trajectory space portions (denoted by hashed areas 342, 344) may become unavailable for navigation by the aerial vehicle. The controller of the vehicle may navigate the trajectory 330 from location 332 while not extending into areas 342, 344. Upon determining at the location 334 prepress towards the unavailable area 342, the vehicle controller may alter the circular trajectory in order to satisfy the trajectory constraints. In some implementations, the vehicle may execute a U-turn towards location 336. It is noteworthy that while executing the U-turn proximate the location 334, the vehicle remains within the target trajectory area (e.g., between the rings 316). While navigating the trajectories 300, 330 the vehicle controller may adapt camera and/or its own orientation to maintain the camera pointing at the SOI (e.g., along direction 348 in FIG. 3B), e.g., as described below with respect to FIGS. 9A-9B.

FIG. 3C illustrates exemplary trajectory of the autonomous aerial vehicle of FIG. 3A configured to populate allowable state space in presence of obstacles during tracking of an SOI, according to some implementations. The allowable state space 370 may be configured based on one or more of a minimum and/or maximum distance from the SOI 315, 316, a restricted portion denoted by the hashed area 372, and/or other information. The trajectory 360 may be configured to populate the allowable state space portion by oscillating between the closest 315 and the farthest 316 boundary extents in accordance with a control policy (e.g., based on lowest jerk). Upon reaching locations proximate to the state space boundaries (e.g., the locations 366, 368), the aerial vehicle may execute a turn (e.g., 364 in FIG. 3C). In one or more implementations (not shown), various other the state space trajectories may be utilized during population of allowable state space 370 (e.g., spiral, random walk, grid, hovering, and/or combination thereof and/or other trajectories). By way of an illustration, at a point in the state space proximate a boundary (e.g., 316 in FIG. 3C), the vehicle controller may execute a right turn. The turn angle may be selected at random from a range (e.g., between 10° and 80°), and/or determined based on one or more prior actions (e.g., history of turns).

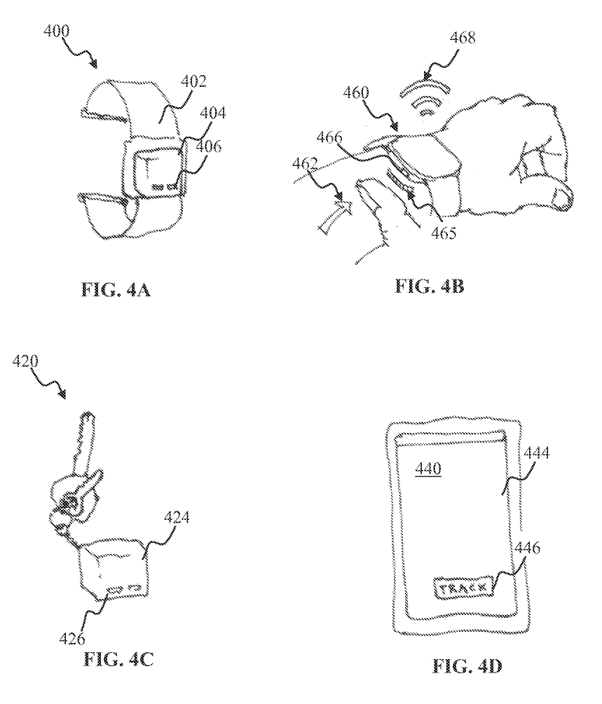

FIGS. 4A-4D illustrate various exemplary wearable devices useful for communicating with autonomous aerial vehicles (e.g., of FIGS. 1, 3A-3B, 8A) during tracking and/or video collection, according to some implementations. In some implementations, a user may utilize a smart watch 400 shown in FIG. 4A in order to configure and/or communicate with an UAV. The device 400 may communicate with the UAV via a wireless communication channel (e.g., radio frequency, infrared, and/or other wave types). The device 400 may comprise a band 402, display 404, and one or more interface elements 406. The interface elements may comprise one or more virtual and/or hardware buttons. Pressing individual and/or combination of buttons may enable the user to communicate one or more instructions to the UAV. Button press pattern, sequence, and/or duration may be used to encode one or more commands. By way of an illustration, a brief press (e.g., shorter than 0.5 s) may indicate a pause, while a longer button press (e.g., longer than 1 s) may indicate a stop. The display 404 may be used to view streamed video collected by the UAV.

The user may use one or more interface elements 406 in order to indicate to the camera an instance of interest (e.g., “awesome”) for recording and/or viewing. In one or more implementation, the smart watch (e.g., the watch 460 of FIG. 4B) device may comprise a dedicated single button configured to communicate the “awesome” command to the camera. The button 466 of the watch 460 in FIG. 4B may be conveniently located to facilitate a single hand motion (shown by arrow 462 in FIG. 4B) and accept user contact forces 465 over spatial extent that is ergonomic for the pad of a thumb. Responsive to the user pressing of the button 466, the watch 460 may issue a command (e.g., “awesome”) to the camera via a wireless interface 468.

In one or more implementation, the wearable device 420 of FIG. 4C may comprise a key fob 424. The key fob may comprise one or more buttons 426 used for operating the UAV data collection.

In some implementations, the wearable device may comprise a smartphone 440 of FIG. 4D. The device 440 may be configured to execute an application (an app) configured to display one or more GUI elements (e.g., 446 in FIG. 4C) on display 444.

Prior to flight (also referred to as “pre-flight”) the user may utilize one or more of the devices 400, 420, 440, 460 in order to configure flight trajectory parameters of the UAV (e.g., altitude, distance, rotational velocity, and/or other parameters), configure recording settings (e.g., 10 seconds before, 20 seconds after the indication of interest), direction and parameters of rotation after a pause (e.g., clockwise, counter clock, alternating, speed). In one or more implementations, the user may load a SOI profile (e.g., comprising the tracking parameters and/or desired trajectory parameters and/or video acquisition parameters and/or environment metadata).

The pre-flight configuration may be performed using a dedicated interface apparatus and/or using other computerized user interface (UI) device. In some implementations, the user may employ a portable device (e.g., smartphone running an app), a computer (e.g., using a browser interface), wearable device (e.g., pressing a button on a smart watch and/or clicker remote), or other user interface means.

The user may further utilize the interface apparatus for flight initiation/SOI selection, calibration, and/or operation of the UAV data collection. In some implementations of SOI selection, the SOI may comprise the user, may be selected in video streamed to a portable device (e.g., smartphone) from the UAV, an object/person carrying the wearable controller configured to broadcasts owners intent to be tracked, and/or other selection methods.

In some implementations of SOI acquisition (e.g., identification) and/or calibration of the acquired SOI (e.g., user identity confirmation), the user may turn in place in order to provide views to enable the UAV controller to acquire the SOI. In one or more implementation the last used SOI may be used for subsequent video acquisition sessions. The UAV controller may provide the user with visual/audio feedback related to state/progress/quality of calibration (e.g., progress, quality, orientation).

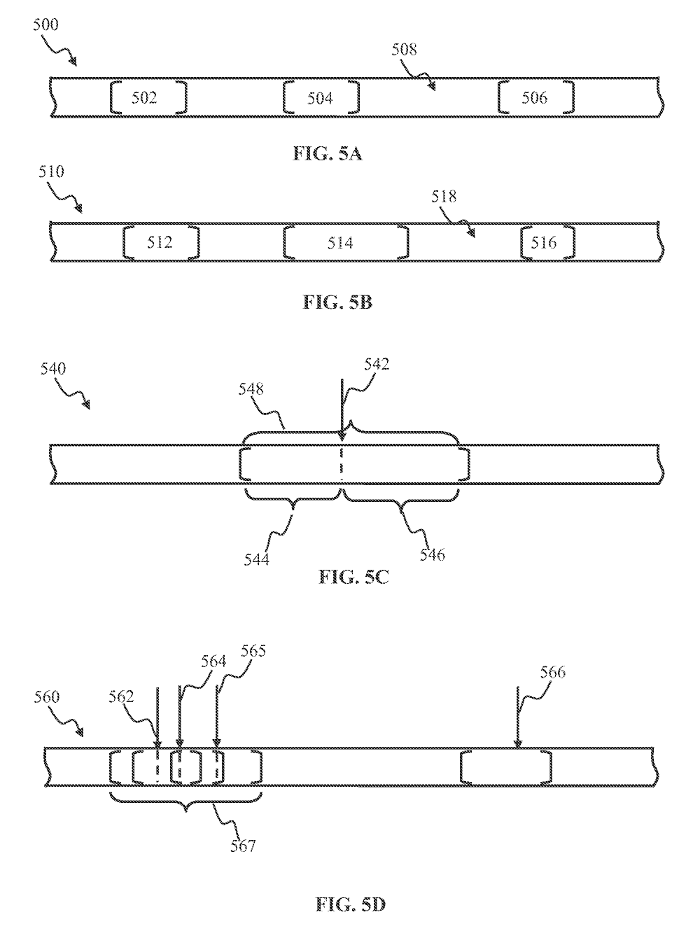

FIGS. 5A through 5D illustrate video acquisition, storage, and display based on an indication of interest, e.g., an event produced by a smart finish line crossing detector configured to produce an alarm when a runner may be detected within a given proximity range, a collision detector configured to produce an alarm when an object may be present within a given range, or a user's indication an awesome moment, or intent to store video content at a greater spatial and/or temporal resolution for subsequent use. In some implementations, longer sections of collected video data may be remotely stored.

Event indicators may be utilized in order to index the longer segment and/or to generate shorter clips, via, e.g., a software process. In one or more implementations, the event indicators may comprise an electrical signal provided to a capture hardware (e.g., to initiate capture) and/or to the buffering hardware (e.g., to modify what is being saved to long term storage out of some part of the buffer), and that this trigger may bear the signal of relevance, by a potentially-automated event detector (e.g., ball in the net). Various electrical signal implementations may be employed, e.g., a pulse of voltage (e.g., a TTL pulse with magnitude threshold between greater than 0 V and less than 5 V, a pulse of frequency, and/or other signal modulation. A spike from a neuron may be used to signal to commence saving a high resolution clip from a memory buffer. In one or more implementations, the event indicator may comprise a software mechanism, e.g., a message, a flag in a memory location. In some implementations, the software implementation may be configured to produce one or more electronic time stamps configured to provide a temporal order among a plurality of events. Various timestamp implementations may be employed such as, a sequence of characters or encoded information identifying when an event occurred, and comprising date and time of day, a time stamp configured in accordance with ISO 8601 standard representation of dates and times, and/or other mechanisms.

In one or more implementations, the time stamps may be used to modify the video storage process, a subsequent processing stage, by, e.g., enabling a greater compression of regions in the inter-clip intervals (e.g., 518, in FIG. 5B) compared to the in-clip intervals (e.g., 516 in FIG. 5B). In some implementations, the inter-clip intervals may be omitted altogether in order to free up storage and/or processing resources for representing the clip data. In one or more implementations the time stamp data may be stored on the mobile camera device, on the user wearable device, communicated to a remote storage (e.g., a cloud depository) and/or other storage apparatus.

FIG. 5A depicts video snippets of uniform length that may be produced based on user indication for use with video acquisition by the aerial vehicle of, e.g., FIG. 1, 3A, 3B, and/or 9A, according to some implementations.

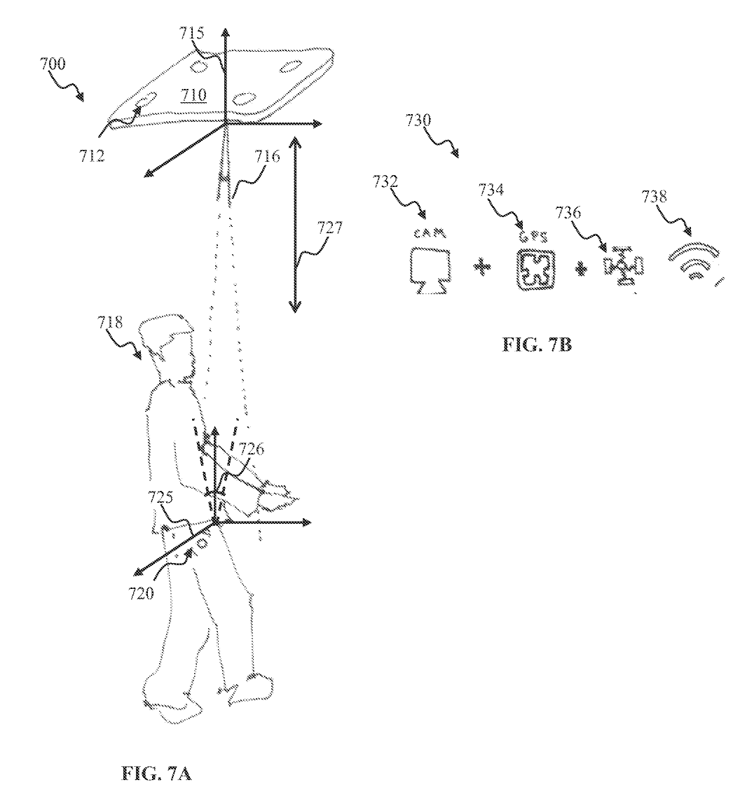

FIG. 5B depicts video snippets of non-uniform lengths that may be produced based on user indication for use with video acquisition by the aerial vehicle of, e.g., FIG. 1, 3A, 3B, and/or 9A, according to some implementations. In some implementations, longer clip lengths may result from computations derived from estimated movement of the SOI, and/or sensors available on a wearable device or aerial platform (e.g., the sensor component 730 described with respect to FIG. 7B, below). For example, the clip may endure until SOI motion reaches a threshold, or until a user ceases to repress the awesome button in a given timeout interval, or when a memory buffer is full.

Based on receipt of one or more indication of interest from the user, an analysis of sensory messages on the smart device 400 and/or aerial platform 100, a controller of the UAV may generate snippets of equal duration 502, 504, 506 within the video stream 500 of FIG. 5A, and or non-equal duration 512, 514, 516 within the video stream 510 of FIG. 5B.

FIG. 5C depicts configuration of a video snippet for use with video acquisition by the aerial vehicle, according to some implementations. Video stream 540 may be produced by a camera disposed on an UAV. Based on detection of the user indication of interest at time denoted by arrow 542, a snippet 548 may be produced. In one or more implementations, the snippet 548 may comprise a pre event portion 544 and a post event portion 546. Duration of the snippet portions 544, 546 may be configured by the user using a computer a browser interface, an application on a portable computing device, and/or a wearable device (e.g., 400, 420, 440, 460), and/or other means.

In some implementations, the video streams 500, 510 may be stored on the UAV and/or streamed to an external storage device (e.g., cloud server). The snippets 502, 504, 506, 512, 514, 516 may be produced from the stored video stream using the snippet duration information (e.g., 544, 546) and time stamps (bookmarks) associated with times when the user indication(s) of interest are detected. In some implementations, e.g., such as illustrated in FIG. 5D, wherein user interest indications 562, 564, 565 may follow closely one after another (e.g., within the snippet duration 548, one or more snippets associated with the indications 562, 564, 566 may be combined into a single snippet 567. The combined snippet may be configured using the start time of the earliest snippet (e.g., corresponding to the indication 562) and stop time of the latest snippet (e.g., associated with the indication 565 in FIG. 5D).

In one or more implementations, snippets associated with user indications of interest may be characterized by video acquisition parameters that may be configured differently compared to the rest of the video stream. By way of an illustration, snippet video may comprise data characterized by one or more of higher frame rate (e.g., for recording bungee or sky-diving jumps, greater bit depth, multiple exposures, increased dynamic range, storing of raw sensor output, and/or other characteristics that may produce larger amount of data (per unit of time) compared to regular video stream portion (e.g., 508, 518, 568 in FIGS. 5A, 5B, 5D). The data rate associated with such enhanced data rate snippets may make it impractical to store and/or transmit the video stream (e.g., 560 in FIG. 5D) in its entirety for the whole sequence. By way of an illustration, onboard memory in a video camera (e.g., Sony HXR-NX30) may be configured to store up to one hour of high definition (HD) video at 60 fps progressive (1080/60p) with 1920×1080 resolution. For a camera that may support a higher image resolution (e.g., 4K 4,096×2,160, and/or frame rate (120 fps, 1200 fps and/or higher), a user may select to record video for periods of interest (e.g., snippets 502 in FIG. 5A) at an increased quality (e.g., higher frame resolution and/or frame rate) compared to the rest of the time. For example, the user may select 4K resolution at 120 fps which would enable the same camera to store video for the duration of 8 minutes. While 8 minutes may be inadequate for continuing coverage of subject of interest, recording video snippets in response to a receipt of indications of interest may enable users to obtain meaningful temporal coverage of user activities. It will be realized by those skilled in the arts that various camera configurations and/or video resolutions may exist and the exemplary numbers provided above may serve to illustrate some implementations of the technology described herein. In one or more implementations, the higher resolution (e.g., snippet) video portion may be characterized by data rate that may be 4-100 times greater than the data rate of the lower resolution (e.g., continuous recording and/or streaming) video.

FIG. 5E depicts an array of video snippets produced based on detection of one or more events provided to the aerial vehicle of FIG. 1 during video acquisition, according to some implementations. Time stamps 562, 564, 565 and 568 may correspond to moments in time where an indication of relevance was provided. In some implementations, individual indication of relevance may produce a potentially unique video clip, even when the recording intervals may overlap in time, as shown in FIG. 5E. In some implementations, clips 572, 574 may comprise video data corresponding to the moment in time indicated by arrow 564, while producing different pixel values. For example, the time stamp 562 may indicate a runner crossing a finish line. Recording settings (e.g., gain control, ISO, focal depth, color space, temporal resolution, spatial resolution, bit depth, and/or other setting) of the clip 572 may be configured for a given SOI crossing the line at time 562. The settings for the clip 574 may be configured at a different setting corresponding to, e.g., another SOI crossing the finish line at time 564. Use of clip-specific video setting may allow user to select spatial and/or temporal resolution in order to, e.g., emphasize video recording of a specific SOI (e.g., a child).

Those skilled in the arts will appreciate that with a finite communication channel and/or data transfer (e.g., write) rates, there may be a limit to the resolution in space, time, bit depth, spectral channels, etc. A limit may exist with regard to the signal available to the imaging sensor based on one or more of the discretization of individual sensors, the quantity of photons, the properties of the compression of air, the quantal efficiency of the sensor and its noise floor, and/or other limiting factors. Given a set of parameters for transducing the energy upon a single optical or acoustic sensing element, a separate bottle-neck may exist for writing the data. This process 570 may be parallelized to enable multiple media clips with different parameter settings. Individual clip may follow a process of storing the previous sampled data 548 and the subsequent sampled

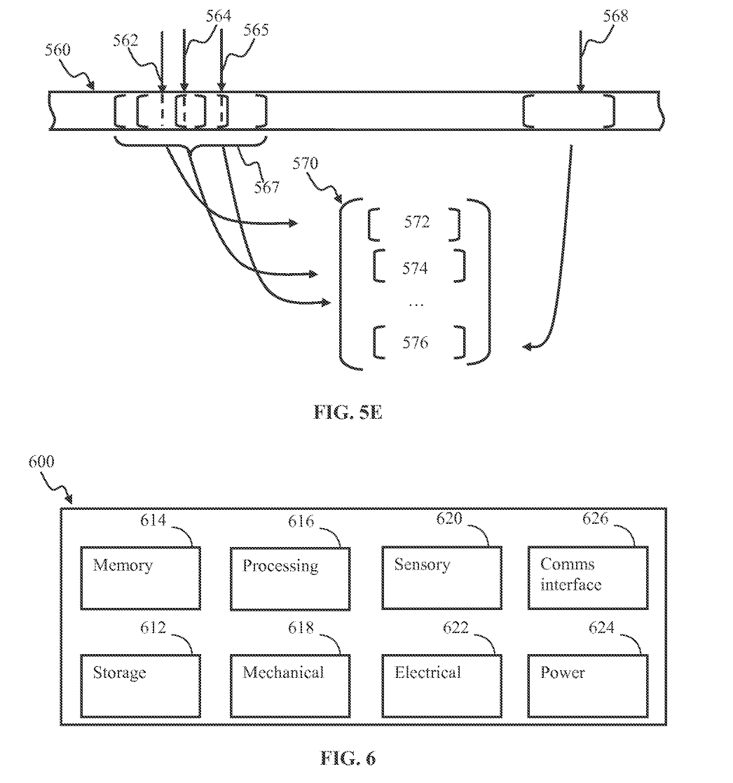

FIG. 6 is a functional block diagram illustrating a computerized apparatus for implementing, inter alia, tracking, video acquisition and storage, motion and/or distance determination methodology in accordance with one or more implementations.

The apparatus 600 may comprise a processing module 616 configured to receive sensory input from sensory block 620 (e.g., cameras 104 in FIG. 1). In some implementations, the sensory module 620 may comprise audio input/output portion. The processing module 616 may be configured to implement signal processing functionality (e.g., distance estimation, storing of snippet data responsive to indications of interest by the user, object detection based on motion maps, and/or other functionality).

The apparatus 600 may comprise storage component 612 configured to store video acquired during trajectory navigation by the autonomous vehicle. The storage component may comprise any applicable data storage technologies that may provide high volume storage (gigabytes), in a small volume (less than 500 mm³, and operate at low sustained power levels (less than 5 W). In some implementations, the storage 612 may be configured to store a video stream (e.g., 500, 510 in FIGS. 5A-5B), and/or snippet portions (e.g., 570 in FIG. 5E).

The apparatus 600 may comprise memory 614 configured to store executable instructions (e.g., operating system and/or application code, raw and/or processed data such as portions of video stream 500, information related to one or more detected objects, and/or other information). In some implementations, the memory 614 may be characterized by faster access time and/or lower overall size compared to the storage 612. The memory 614 may comprise one or more buffers configured to implement buffering operations described above with respect to FIG. 5E.

In some implementations, the processing module 616 may interface with one or more of the mechanical 618, sensory 620, electrical 622, power components 624, communications interface 626, and/or other components via driver interfaces, software abstraction layers, and/or other interfacing techniques. Thus, additional processing and memory capacity may be used to support these processes. However, it will be appreciated that these components may be fully controlled by the processing module. The memory and processing capacity may aid in processing code management for the apparatus 600 (e.g., loading, replacement, initial startup and/or other operations). Consistent with the present disclosure, the various components of the device may be remotely disposed from one another, and/or aggregated. For example, the instructions operating the haptic learning process may be executed on a server apparatus that may control the mechanical components via network or radio connection. In some implementations, multiple mechanical, sensory, electrical units, and/or other components may be controlled by a single robotic controller via network/radio connectivity.

The mechanical components 618 may include virtually any type of device capable of motion and/or performance of a desired function or task. Examples of such devices may include one or more of motors, servos, pumps, hydraulics, pneumatics, stepper motors, rotational plates, micro-electro-mechanical devices (MEMS), electroactive polymers, shape memory alloy (SMA) activation, and/or other devices. The mechanical component may interface with the processing module, and/or enable physical interaction and/or manipulation of the device. In some implementations, the mechanical components 618 may comprise a platform comprising plurality of rotors coupled to individually control motors and configured to place the platform at a target location and/or orientation.

The sensory devices 620 may enable the controller apparatus 600 to accept stimulus from external entities. Examples of such external entities may include one or more of video, audio, haptic, capacitive, radio, vibrational, ultrasonic, infrared, motion, and temperature sensors radar, lidar and/or sonar, and/or other external entities. The module 616 may implement logic configured to process user commands (e.g., gestures) and/or provide responses and/or acknowledgment to the user.

The electrical components 622 may include virtually any electrical device for interaction and manipulation of the outside world. Examples of such electrical devices may include one or more of light/radiation generating devices (e.g., LEDs, IR sources, light bulbs, and/or other devices), audio devices, monitors/displays, switches, heaters, coolers, ultrasound transducers, lasers, and/or other electrical devices. These devices may enable a wide array of applications for the apparatus 600 in industrial, hobbyist, building management, surveillance, military/intelligence, and/or other fields.

The communications interface may include one or more connections to external computerized devices to allow for, inter alia, management of the apparatus 600. The connections may include one or more of the wireless or wireline interfaces discussed above, and may include customized or proprietary connections for specific applications. The communications interface may be configured to receive sensory input from an external camera, a user interface (e.g., a headset microphone, a button, a touchpad, and/or other user interface), and/or provide sensory output (e.g., voice commands to a headset, visual feedback, and/or other sensory output).

The power system 624 may be tailored to the needs of the application of the device. For example, for a small hobbyist UAV, a wireless power solution (e.g., battery, solar cell, inductive (contactless) power source, rectification, and/or other wireless power solution) may be appropriate.

FIG. 7A illustrates exemplary use of an aerial vehicle for tracking a person carrying a wearable device, according to some implementations. System 700 of FIG. 7A may comprise a multi-rotor UAV 710 comprising a plurality of propellers 712 and a sensor component. The UAV 700 may be configured to track (follow) a person 718. The person may carry a wearable smart device 720. The wearable device 720 may comprise a sensor apparatus embodied in a smart phone (e.g., 440 of FIG. 4C, smart watch (e.g., 400 of FIG. 4A), and/or other device.

FIG. 7B illustrates a sensor apparatus 730 that may be embodied within the UAV 700 and/or of the wearable device 720 in FIG. 7A. The sensor apparatus 730 may comprise one or more camera components 732. The camera component 732 when embodied with the UAV sensor apparatus may be characterized by aperture 716 and provide a view of the SOI. The camera component 732 when embodied with the smart device sensor apparatus may be characterized by aperture 726 and provide a view of the SOI. The sensor apparatus 730 may comprise a global positioning component 734. It will be recognized by those skilled in the arts that various global positioning (geolocation) technologies may be utilized such as Global Positioning System (GPS), Global Navigation Satellite System (GLONASS), Galileo, and/or other geolocation systems. As used herein the term GPC may refer to any applicable geolocation system.

The GPS component 734 disposed in the UAV apparatus 710 and the wearable device 720 may provide position information associated with the UAV and the SOI, respectively. The sensor apparatus 730 may comprise a measurement component (MC) 736. The MC 736 may comprise one or more accelerometers, magnetic sensors, and/or rate of rotation sensors configured to provide information about motion and/or orientation of the apparatus 730. The MC 736 disposed in the UAV apparatus 710 and the wearable device 720 may provide motion information associated with the UAV and the SOI, respectively. The sensor apparatus 730 may comprise a wireless communications component 738. The communications component 738 may be configured to enable transmission of information from the UAV to the wearable apparatus and vice versa. In some implementations, the communications component 738 may enable data communications with a remote entity (e.g., a cloud server, a computer, a wireless access point and/or other computing device). In one or more implementations, the communications component 738 may be configured to provide data (e.g., act as a wireless beacon) to a localization process configured to determine location of the apparatus 710 with respect to the SOI 718 and/or geo-referenced location.

The apparatus 710 may be characterized by a “platform” coordinate frame, denoted by arrows 715. The wearable device 720 and/or the SOI 718 may be characterized by subject coordinate frame, denoted by arrows 725 in FIG. 7A. The apparatus 710 and/or the SOI 718 may be characterized by a position, motion, and/or orientation in three dimensional (3D) space. The position may be expressed in a geo-referenced coordinates (e.g., latitude, longitude, and elevation), locally references (e.g., x, y, z coordinates with respect to a reference position). In some implementations the SOI position may be selected as the reference. Motion and/or position data provided by the sensor apparatus (e.g., 730) disposed on the platform 710 may be collected in the platform coordinates (e.g., the camera 732 and/or the MC 736) and/or geo-referenced coordinates (e.g., the GPS 734). The localization process may be configured to transform position, and/or motion of the apparatus 710 and/or the SOI 718 to the coordinate frame 725, and/or the geo-referenced coordinate.

In some implementations, a camera component of the apparatus 710 may be mounted using a gimbaled mount configured to maintain camera component view field extent (e.g., 716 in FIG. 7A) oriented in the direction of the SOI 718. The gimbaled mount may comprise one or more gimbal position sensors (e.g., position encoders, level sensors, and/or stepper motors) configured to provide camera orientation data. Video and orientation data provided by the camera component of the apparatus 710 and/or wearable device 720 may be utilized by the localization process. In some implementations, the localization process may utilize a coordinate transformation configured to transform the SOI location and/or orientation in visual field 716 of the camera component relative to the camera frame. In some implementations wherein the camera component 732 may comprise a stereo camera (comprising, e.g., left/right image sensors), the position and/or orientation may be determined based on a disparity measure provided by the stereo imagery. In some implementations, the disparity determination may comprise encoding interleaved and/or concatenated sequence of left/right images provided by the component 732, e.g. as described in co-pending and co-owned U.S. patent application Ser. Nos. 14/285,414, entitled “APPARATUS AND METHODS FOR DISTANCE ESTIMATION USING MULTIPLE IMAGE SENSORS”, filed on May 22, 2014, 14/285,466, entitled “APPARATUS AND METHODS FOR ROBOTIC OPERATION USING VIDEO IMAGERY”, filed on May 22, 2014, 14/285,385 entitled “APPARATUS AND METHODS FOR REAL TIME ESTIMATION OF DIFFERENTIAL MOTION IN LIVE VIDEO”, filed on May 22, 2014, and/or XXXXX entitled “APPARATUS AND METHODS FOR MOTION AND DISPARITY ESTIMATION FROM MULTIPLE VIDEO STREAMS”, filed on XX, 2014, each of the foregoing incorporated herein by reference in its entirety.

The UAV apparatus 710 and the wearable device 720 may cooperate in order to determine and/or maintain position of the UAV relative the SOI. In some implementation, the position determination may be configured based on a fusion of motion data (e.g., position, velocity, acceleration, distance, and/or other motion data) provided by the UAV sensor apparatus and/or the wearable device sensor apparatus (e.g., the apparatus 730).

In some implementations images provided by a stereo camera component may be used to localize the SOI within the camera image. The subject localization may comprise determination of the SOI position, distance, and/or orientation. The SOI position datum determined from the camera 732 imagery may be combined with data provided by the position component (734), measurement component 736, camera gimbal position sensors, and/or wireless beacon date in order to orient the camera view field 716 such as to place the SOI in a target location within the frame. In some implementations, e.g., those described with respect to FIG. 9A, the target location may comprise frame center (e.g., as shown in frame 932 in FIG. 9A). In one or more implementations, the target SOI configuration within the frame may comprise positioning the camera such that the SOI is oriented towards the center of the camera frame. In some implementations, placing the SOI at the target location may comprise adjusting distance (e.g., 727) between the camera and the SOI. In one or more implementations, the distance 727 may be configured by a user via the wearable device 720. The apparatus 710 may execute a plurality of actions configured to maintain the SOI at the target location within video frames. In some implementations, the action may be configured to execute a flyby, an orbit, and/or fly-away trajectories.

The wireless component 738 may be utilized to provide data useful for orienting the camera view field 716 such as to place the SOI in a target location within the frame. In one or more implementations, the wireless component data may comprise receiver signal strength indication (RSSI), time of arrival, and/or other parameters associated with transmission and/or receipt of wireless data by the beacon. The beacon may provide an SOI-centric position, and a platform-centric direction of SOI.

By way of an illustration, augmenting GPS data with inertial motion measurement may enable to reduce errors associated with SOI and/or UAV position determination. Combining position and/or velocity data provided by the UAV and the wearable device GPS component may enable reduction in systematic error associated with the GPS position determination.

FIG. 8A illustrates exemplary use of a quad-rotor UAV for tracking a bicyclist, according to one implementation. The UAV 800 may comprise 3, 4, 8, or 8 motors driving propellers 802. The UAV 800 may comprise a sensory/processing component 806. In some implementations, the component 806 may comprise, e.g., the sensor component 730 described above with respect to FIG. 7B. The sensor component 806 may comprise a camera configured to detect the cyclist 810 using, e.g., identification patch 816. The identification patch may be disposed on the cyclist's helmet (as shown in FIG. 8B), jersey sleeve and/or other locations. The patch 816 may comprise a barcode, QR code, and/or other identification means. In some implementations, the identification may be based on wireless communications protocol (e.g., WiFi, RFID, Bluetooth and/or communication means) between the UAV and the bicyclist. The UAV 800 may be configured to execute one or more trajectories in order to provide views of the SOI from multiple perspectives. One such circular trajectory is shown by arrow 804 in FIG. 8A.

The bicycle may comprise a smart grip apparatus 820 configured to enable the cyclist to operate the UAV during tracking and/or data collection. FIG. 8B illustrates one implementation of the smart grip apparatus of FIG. 8A. The apparatus 820 may comprise a sleeve 826 that may be fitted onto the bicycle handlebar 830. In some implementations, the sleeve 826 may replace the rubber handlebar grip.

The smart grip apparatus 820 may comprise a button 824. The user may activate the button 824 (as shown by arrow 832 in FIG. 8B) in order to power on/off the grip apparatus 820, select a mode of operation, and/or perform other functions. In some implementations, the mode of operation may comprise setup mode, navigation mode, video acquisition mode, and/or other functions.

The sleeve 826 may be actuated using rotational motion (e.g., shown by arrow 822 in FIG. 8B indicating forward rotation). The forward/reverse rotation may be used to increment/decrement a control parameter associated with the UAV trajectory. In one or more implementations, the control parameter may comprise a distance, an azimuth between the UAV and the object of interest, elevation of the UAV, rotational rate (e.g., speed along the trajectory 804), and/or other parameter (e.g., direction of the UAV rotation).

The smart grip apparatus 820 may comprise an actuator 834. In one or more implementations, the actuator 834 may comprise a bi-action shifter lever. The user may activate the actuator 834 in two directions, e.g., as shown by arrows 836, 838 in FIG. 8B. In some implementations, the control action 836 may be configured to convey an indication of interest to the UAV (e.g., “awesome” event described above with respect to FIGS. 4A-5E.

In one or more implementations, the control action 838 may be used to select mode of operation of the UAV tracking and/or data collection.

FIG. 9A is a graphical illustration depicting tracking of a moving subject of interest using a mobile camera, according to some implementations. In some implementations the subject of interest may comprise a person, a vehicle, an animal, and/or other object (e.g., a plume of smoke, an atmospheric cloud). The mobile camera may be mounted on an UAV, and/or other mobile apparatus.

Panel 900 in FIG. 9A presents a diagram of the change in position of the SOI (denoted by triangles in FIG. 9A) and the aerial camera denoted by squares in FIG. 9A between two moments in time: t1, t2. Time instance t1 may be referred to as the current time, having the current SOI position 910, and the current camera position 920 associated therewith. The SOI may move from its current position 910 at t1 towards position 912 with velocity 904. At a time instance t2>t1, the SOI may be at location 912 separated from the position 910 by distance 906. The camera may be displaced from its current position 920 at time1 towards the position 922 at velocity 924. The velocity vectors 904, 924 may be determined at a time t0<t1. At a time instance t2>t1, the camera may be disposed at location 922 separated from the position 920 by distance 926.

The separation vector 908 between the camera position 920 and the SOI position 910 at time t1 may be configured in accordance with a specific task. In some implementations, the task may comprise acquisition of a video of the SOI by the UAV with the SOI being in a particular portion (e.g., a center) of the video frame. At time t1, the vector 908 may denote orientation of the camera configured in accordance with the task specifications. At time t2, the camera orientation may be denoted by vector 916. With the camera pointing along direction 916 at time t2, acquisition of the video footage of the SOI may be unattainable and/or characterized by a reduced angular and/or depth resolution compared to the camera orientation denoted by line 914. In some implementation, a controller component may be configured to determine angular adjustment 928 that may be applied in order to point the camera along the target direction 914 using a state determination process configured to reduce a discrepancy between the current state (current orientation denoted by broken line 916) and the target state 914, e.g., as described in detail with respect to FIG. 9B. The adjustment 928 may be effectuated by modifying orientation of the UAV, and/or rotating the camera on the UAV. The camera direction may be modified continuously and/or in discrete increments along the trajectory 926. In one or more implementations, magnitude of angular adjustment increment may be selected to cause displacement of the camera frame location with respect to the SOI by a fraction (e.g., no more than 1/10) of the frame width between consecutive frames in the video. The camera orientation adjustment (e.g., 928 in FIG. 9A) may enable the camera to maintain SOI (e.g., user) in a target portion (e.g., center) of the video frame thereby improving user experience associated with video acquisition. The camera orientation adjustment (e.g., 928 in FIG. 9A) may enable acquisition of video that is characterized by a reduced (or altogether eliminated) absence panning motion that may be present in video acquired from a moving platform. In one or more implementations, the camera orientation may be adjusted at a rate configured smaller than 20°/second to obtain smooth video appearance. For video acquired at 30 frames per second (fps), the camera adjustment (e.g., 928 in FIG. 9A) may be effectuated at a rate selected between 0.02 and 2 degrees between consecutive frames. For video acquired at 120 frames per second (fps), the camera adjustment may be effectuated at a rate selected between 0.01 and 0.5 degrees between consecutive frames.

The control component may utilize various sensory information in order to determine the camera orientation adjustment (e.g., 918). In some implementations, the sensory information may comprise one or more images obtained by the mobile camera. Panels 930, 932, 934, 936, 938, 939 illustrate exemplary image frames comprising representation of the SOI useful for camera orientation adjustment.

Panel 930 may represent SOI representation 944 that is disposed distally from target location (e.g., not in the center of the frame as shown by the representation 942 in panel 932). At time t1, the control component may determine expected position of the SOI at time t2, shown by representation 944 in panel 934, in absence of camera orientation adjustment. Application of the adjustment 928 may enable the camera to obtain the SOI representation 946, shown in panel 936. The representation 936 may be referred to as matching the target configuration of the task (e.g., being located in center of frame 936).

In some implementations, the control component may evaluate the expected SOI position within a frame by applying one or more actions (e.g., the adjustment 928). The control component may represent adjustment actions stochastically, and/or may implement a control policy that may draw samples from a stochastic representation of an internal state (e.g., a stochastic representation of one or more variables such as position, velocity, acceleration, angular velocity, torque, and/or control command, as they apply to one or both the SOI 912 and the camera 922. Panel 938 illustrate a distribution (denoted by dots 948 in FIG. 9A) of expected SOI positions in absence of trajectory adjustment. Panel 939 illustrates a distribution (denoted by dots 949 in FIG. 9A) of expected SOI positions in obtained based on trajectory adjustment in accordance with a target policy (e.g., maintaining SOI in frame center).

In some implementations, the stochastic representation of internal state may be configured using a parametric form. A probability distribution of a state variable (e.g., estimated future position) may be maintained with a parametric representation (e.g., a Gaussian distribution with a given mean and variance). A cost function may be utilized for trajectory navigation. In some implementations, the cost function may be configured based on proximity to SOI, variability of vehicle position and/or speed. The cost function may be configured using a product of a function indicating the distance to an object (e.g., a stepwise or sigmoidal cost over location, configured to characterize proximity of the SOI and/or objects to the vehicle) and a probability distribution of a state variable (e.g., estimated future position), as assessed by a function or its approximation. In one or more implementations, the cost function may be configured to characterize e.g., distance of an outer edge (proximal surface) of a building from the vehicle. A stepwise cost function may be configured to produce a zero value for the open space up to the wall (e.g., up to 5 meters), and a value of one for the blocked off region behind. A sigmoid may provide a smooth transition and enable to handle an uncertainty that may be associated with location of the vehicle and/or objects and/or the relative position of the wall. Those skilled in the art mat appreciate that risk of a candidate action may reduce to the product of a fixed cost co-efficient and an evaluation of an error function (e.g., the cumulative distribution function of a Gaussian), which may be stored in a lookup table.

The parametric stochastic representation may be sampled in order to obtain a distribution of samples that may provide (within noise bounds), a measure of a corresponding cost function that may reflect a given user parameter. In some implementations, the probability distribution of the state space may be sampled via a statistical method (e.g., Gibbs sampling, a Monte Carlo Markov Chain, and/or some other sampling method) whose cost could be evaluated after the result of each independent sample, such that a command is accepted (e.g., within bounds, according to user criteria of desired smoothness), or rejected (e.g., unacceptably jerky), by a search process over actions. Such a search process may be evaluated on each or any of the samples, such that the magnitude of the K samples within the criteria out of N total processed, is above or below a threshold (e.g., according to the confidence interval of a binomial distribution with a particular stringency alpha), terminating the search process over actions (e.g., for acceptance of the action) and/or terminating the evaluation of a particular action (e.g., for rejection). Some implementations may include a specification for what policy to apply in the condition that the search process does not terminate in time, or by the X^{th} sample (e.g., that the system return to a stable state, despite violation of some user criteria). Some implementations may include a method for choosing the next candidate action (e.g., based on the estimated gradient or curvature of K/N for each or any criteria), potentially increasing the likelihood that an action selection terminates with fewer action evaluations.

The control component may utilize posterior samples of the candidate world state given that a proposed action would be attempted 939 or no action would be attempted 938. The representations of a control state 948 and 949 may reflect computational stages in the ongoing processing of sensory data for autonomous navigation by a controller and/or may be used to indicate an anticipated future sensory state to a user via a GUI.

FIG. 9B is a graphical illustration depicting camera orientation adjustment when collecting video of a stationary subject of interest, according to some implementations.

In FIG. 9B, the SOI 960 may remain at the same location during video collection by a mobile camera, denoted by rectangles 962, 964 in FIG. 9B. At time t4 the may be characterized by position 962, orientation 972, and/or angular error 966 between the target camera direction 968 and actual camera orientation 972. The camera may transition from location 962 to location 964 along trajectory 976. At time t5>t4 the camera may be characterized by position 964, orientation 974, and/or angular pointing error 978 between the target camera direction 970 and actual camera orientation 974. The angular camera pointing error 978 at time t5 may be comprised of the initial camera pointing error 966 at time t4 and the rotation induced error 988. Dotted line 980 in FIG. 9B denotes camera orientation in absence of initial camera pointing error 966. It is noteworthy, that although the camera positioning for FIGS. 9A-9B is described in terms of orientation and/or angular error, various control space parameters may be employed in order to orient the camera along target direction. In one or more implementations, the control parameters may comprise one or more of the UAV rotation rate, radial velocity, rotation rate and/or velocity associated with one or more rotors of the A?UV (e.g., 802 in FIG. 8A), and/or other parameters.

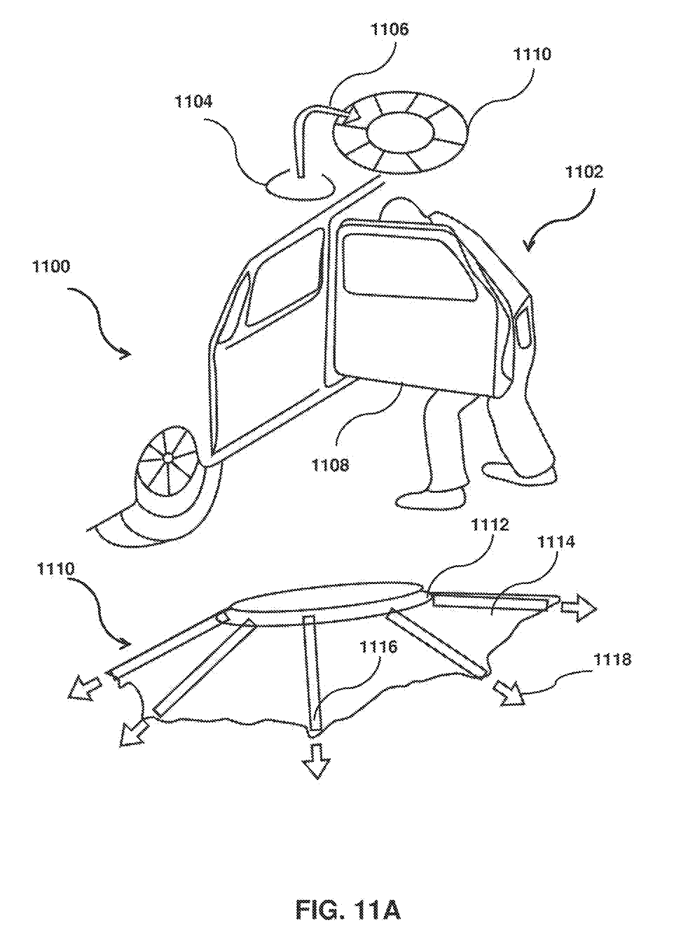

In some implementations, the video acquisition methodology described herein may be utilized for providing additional services besides video acquisition. FIGS. 10A-10C illustrate use of an umbrella UAV for providing cover from the elements while tracking a pedestrian, according to some implementations. FIG. 10A is a side view of an umbrella UAV configured to provide cover from rain while tracking a pedestrian. The UAV platform 1000 may comprise multiple rotors 1004 and configured to support umbrella, as shown in FIG. 10A. The UAV 1000 may be configured to follow a SOI 1006 using any applicable methodology described herein. In some implementations, the UAV 1000 may hoover above the SOI 1006 at a given height while protecting the SOI from rain, as shown in FIG. 10A. In one or more implementations, e.g., as shown in FIG. 10B. FIG. 10A is a top plan view of the umbrella UAV 1010 configured to provide cover from sun while tracking the SOI 1006. The UAV 1010 may comprise a sensor component configured to determine wind speed, sun elevation, inertial measurement component, a camera, and/or GPS component. The UAV 1010 controller may utilize sensor information in order to, e.g., determine an offset distance 1012 that may provide optimum shade coverage (e.g., as characterized by maximum overlap between the umbrella 1016 footprint and the SOI cross-section, in some implementations).

FIG. 10C is a side view of an umbrella UAV configured to avoid obstacles while provide cover for an SOI, according to some implementations. The UAV 1020 may comprise a sensor component. e.g., comprising a camera and/or a proximity sensor, configured to provide information related to potential obstacles, e.g., a road sign 1024. Upon detecting an obstacle, the UAV 1020 may modify tracking trajectory (e.g., as shown by arrow 1026) in order to avoid a collision with the obstacle 1024.

FIGS. 11A-11B illustrate use of a vehicle-mounted umbrella UAV for tracking a SOI, according to some implementations.

As shown in FIG. 11A, an UAV 1110 may be adapted to dock to a receptacle 1104 disposed on top of a vehicle, e.g., a car 1100. Upon detecting opening of the vehicle door 1108, the UAV may become activated and transition (as shown by arrow 1106 in FIG. 11A) from the dock location to a location above the respective door. In some implementations, e.g., such as illustrated in FIG. 11A, the UAV 1110 may comprise a retractable umbrella configured to afford protection to a passenger 1102 from the elements. The umbrella may comprise retractable spokes 1116 coupled to a base 1112. Individual spokes 1116 may extend/collapse along direction shown by arrow 1118 in FIG. 11A. The spokes 1116 may support a plurality of flexible elements 1114. Individual elements 1114 may be fabricated from a suitable material (e.g., GoreTex®).

FIG. 11B illustrated an exemplary trajectory of the vehicle mounted UAV. Upon detecting opening of the house door 1128, the UAV controller may instruct the AUV to traverse the trajectory 1124 from the dock 1122 disposed on the vehicle 1120 towards the door 1128. The UAV may hoover at a safe distance above an SIO during transit from the door 1128 back to the vehicle 1120 thereby offering protection from sun, rain, and/or other elements.

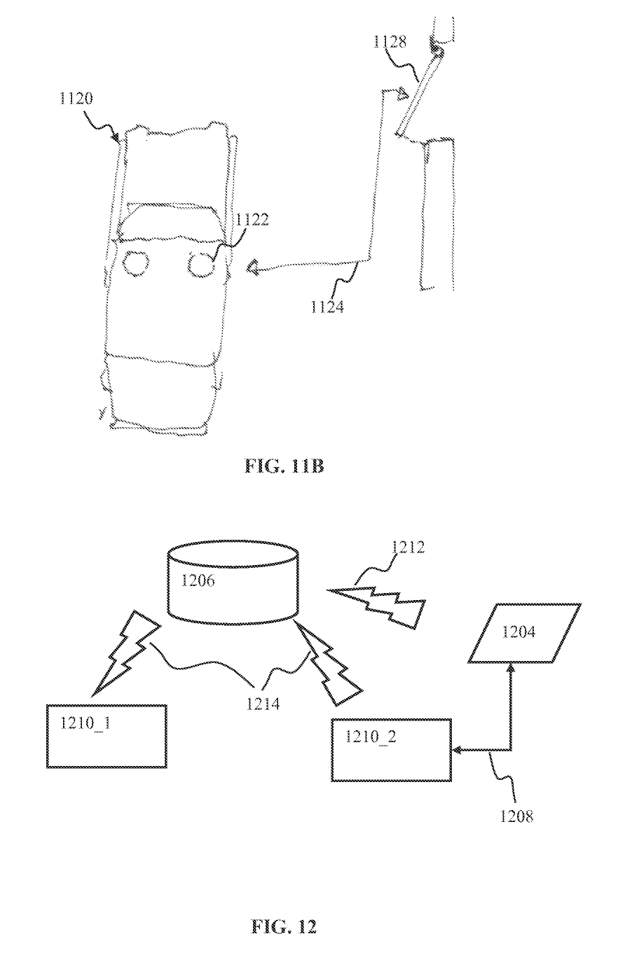

FIG. 12 illustrates a computerized system configured for implementing SOI tracking methodology of the disclosure, in accordance with one implementation. The system 1200 may comprise a computerized entity 1206 configured to communicate with one or more controllers 1210 (e.g., 1210_1, 1210_2). In some implementations, the entity 1206 may comprise a computing cloud entity (e.g., a cloud service, a server, in a public, private or hybrid network). In one or more implementations, the entity may comprise a computer server, a desktop, and/or another computing platform that may be accessible to a user of the controller 1210. Individual controllers 1210 may be configured to operate an aerial platform and/or video acquisition by a camera, e.g., as shown and described with respect to FIGS. 1, 3A, 7A, 8A. The controller 1210 may comprise a computerized apparatus embodied within the UAV and/or portable user device (e.g., 440 in FIG. 4D). In some implementations of the cloud computing services, one or more learning controller apparatus 1210 may communicate with the entity 1206 in order to access computing resources (e.g., processing cycles and/or memory) in order to, e.g., detect SOI using fusion of sensory data provided by, e.g., the sensor component 730 of FIG. 7B. In some implementations, the controller apparatus 1210 may communicate with the entity 1206 in order to save, load, and/or update, their processing configuration. In some implementations, the learning controller apparatus 1210 may communicate with the entity 1206 in order to save, and/or retrieve learned associations between sensory context and actions of the UAV. In one or more implementations, the context may comprise an event (e.g., sky dive, bike jump), an occurrence of an object (e.g., a person appearing in camera field of view), a timer expiration, a command by a user (e.g., a button press, an audio indication, and/or other command), a location, and/or other configuration of environment.

In FIG. 12, one or more controller apparatus (e.g., 1210_1) may connect to the entity 1206 via a remote link 1214, e.g., WiFi, and/or cellular data network. In some implementations, one or more controller apparatus (e.g., 1210_2) may connect to the entity 1206 via a local computerized interface device 1204 using a local link 1208. In one or more implementations, the local link 1208 may comprise a network (Ethernet), wireless link (e.g., Wi-Fi, Bluetooth, infrared, radio), serial bus link (USB, Firewire,) and/or other. The local computerized interface device 1204 may communicate with the cloud server entity 1206 via link 1212. In one or more implementations, links 1212 and/or 1214 may comprise an internet connection, and/or other network connection effectuated via any of the applicable wired and/or wireless technologies (e.g., Ethernet, Wi-Fi, LTE, CDMA, GSM, and/other).

In one or more applications that may require computational power in excess of that that may be provided by a processing module of the controller 1210_2 the local computerized interface device 1204 may be used to perform computations associated with operation of the robotic body coupled to the learning controller 1210_2. The local computerized interface device 1204 may comprise a variety of computing devices including, for example, a desktop PC, a laptop, a notebook, a tablet, a phablet, a smartphone (e.g., an iPhone®), a printed circuit board and/or a system on a chip (SOC) comprising one or more of general processor unit (GPU), field programmable gate array (FPGA), multi-core central processing unit (CPU), an application specific integrated circuit (ASIC), and/or other computational hardware.

In one or more implementations, the data link 1214 may be utilized in order to transmit a video stream and/or accompanying time stamps, e.g., as described above with respect to FIGS. 5A-5E.

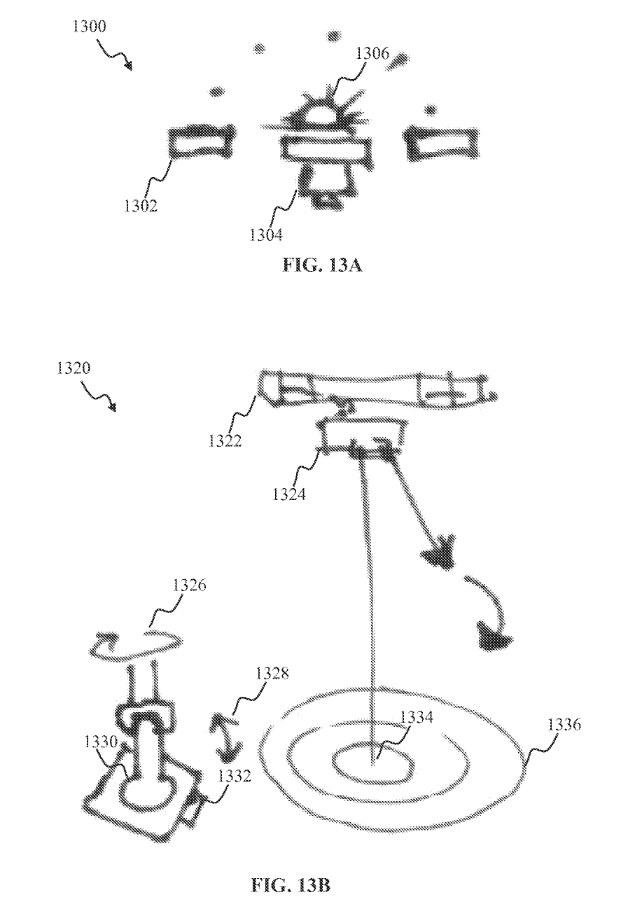

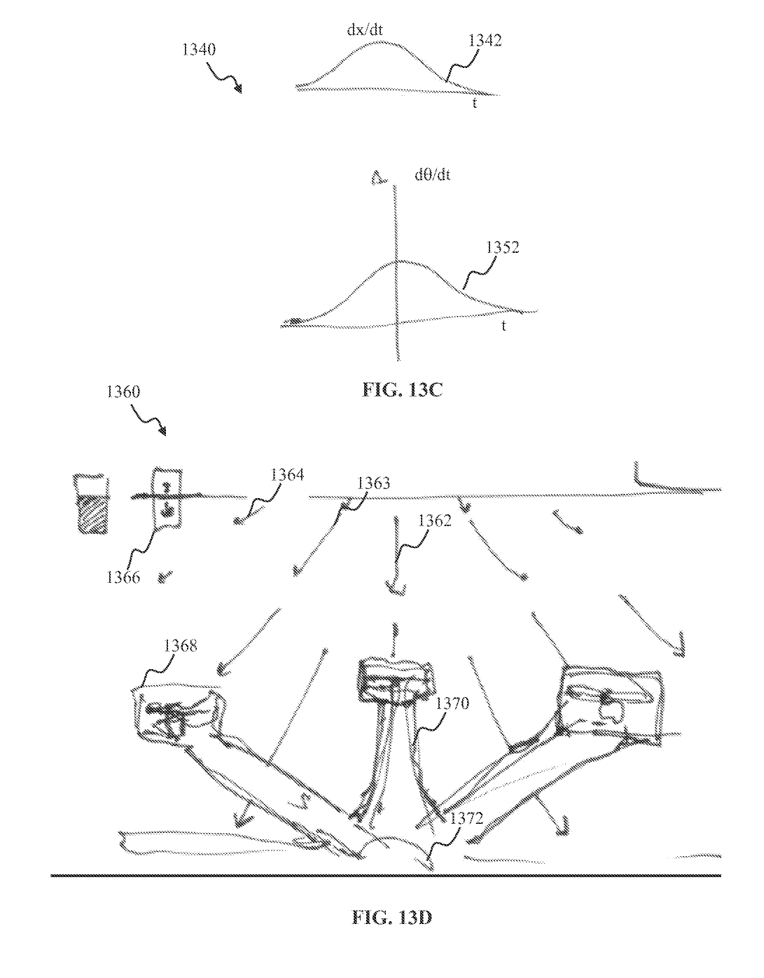

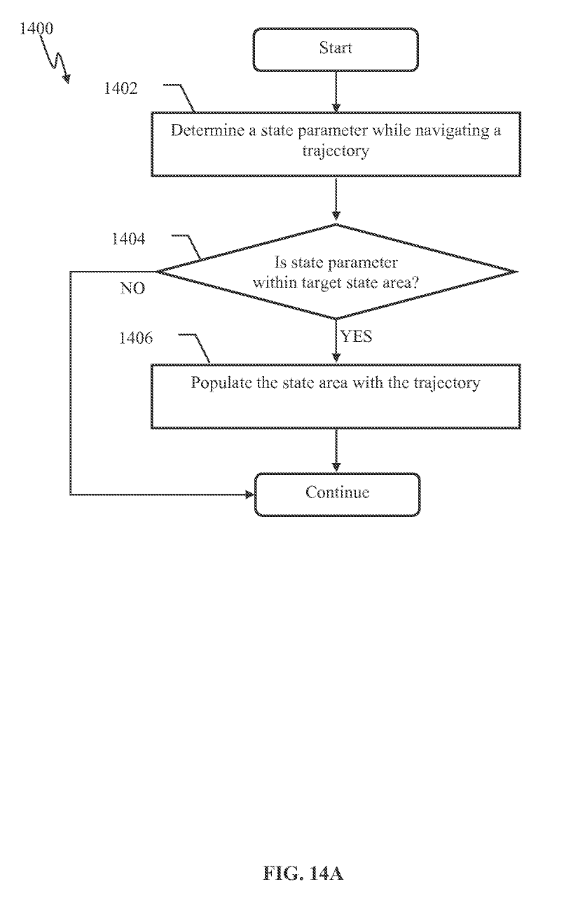

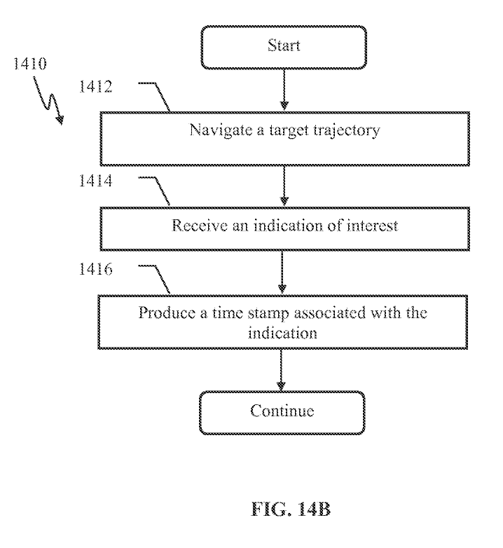

FIG. 13 illustrates an aerial platform comprising a camera. The platform 1300 may be supported by forces applied along locations 1302 of the body frame. One or more upward facing cameras 1306 may be able to pivot so as to capture images and/or video from an overhead region. In some implementations, the one or more cameras 1306 may comprise an optical attachment (e.g., a lens and/or a mirror) that may provide imaging of a wider field of view. Images of wider field of view may enable use of aerial landmarks for navigation (e.g., ceilings, building facades, trees, and/or other features). The platform 1300 may comprise a downward facing camera 1304. The camera 1304 may be optimized for generating a video while following a SOI, estimating velocity, visualizing a candidate location for landing, and/or performing other actions.

FIG. 13B illustrates a system configured to manipulate a camera useful for tracking and/or video acquisition of a SOI. The system 1320 may be comprised of a body 1322 configured to generates thrust (e.g., via motorized propellers) and a camera component 1324 that may contain one or more imaging sensors. The camera component 1324 may be characterized by an optical aperture 1332 (e.g., a lens) of optical path to imaging plane. In some implementations, the camera component 1324 may be configured to provide data useful for disparity determination (e.g., using left/right sensors). In one or more implementations, individual sensors of the camera component may be matched to different optics (e.g., wide angle lens, telephoto lens, filters, and/or other optical elements), be configured to produce images at different spatial and/or temporal resolution.

During image acquisition, the system 1320 may be configured to navigate a target trajectory. In one or more implementations, the trajectory navigation may comprise maintaining a location in space, varying platform vertical position, and/or horizontal position (e.g., oscillating between two locations at a defined frequency, potentially pausing at extrema to capture image samples) and/or performing of other actions.

The physical structure of the camera component 1324 may be configured to maintain a constant relative position of individual optical elements while supporting effectors to actuate angular displacements that change the angular elevation 1328 and/or azimuth 1326 with respect to a coordinate system defined by the body frame 1322 and/or a world frame. The azimuthal rotation 1326 of the imaging plane may be enabled by a rotation mechanism 1330. The imaging plane in the camera module 1324 may be centered over a visually-defined SOI and/or a GPS-defined coordinate, enabling a sequence of visualization in polar coordinates. For example, a contiguous change in azimuth 1326 may enable an imaging sensor to capture a series of images along a circular path 1336. A change in the elevation may enable imaging along a different circular path, such that a fixed sampling rate of video and a constant angular velocity of azimuth may produce a greater number of pixel samples for a given square centimeter that is closer to the location 1334 below the camera module, than at regions more displaced in the horizontal axis (e.g., locations along path 1336). The 1330—a mechanism that supports rotation of the imaging plane

Imaging sequences may be used to construct one or more of representations of the physical layout of a scene, the surface properties of objects in a scene (e.g., appearance, material, reflectance, albedo, illumination, and/or other surface properties), changes in the scene (e.g., changes in temperature or the movement of people, animals, plants, vehicles, fluids, objects, structures, equipment, and/or other changes in the scene), changes in surface properties of the scene (e.g., the spectral reflection of surfaces), and/or other aspects pertaining to the region near a SOI or GPS defined landmark, or otherwise. For example, the system 1320 may be used to reconstruct a building structure including a surface map of thermal emissions, localized around a SOI (e.g., a window that may or may not have good insulation).

FIG. 13C illustrates state space parameters useful for controlling a vehicle during navigation of target trajectory (e.g., 1336 in FIG. 13A). The state space 1340 may be characterized by probability distributions 1342, 1352. The state space representation may indicate a state of the rate of change of the position 1342 and/or angle 1352 of a platform (e.g., 1322 in FIG. 13B) and/or a camera component (e.g., 1324 in FIG. 13B). State space parameters may be updated based on one or more of the previous state, the nature of additional accumulated sensor evidence, a prior probability appropriate to the behavior, location of the system 1320, and/or other information.

FIG. 13D illustrates a mobile camera apparatus configured for SOI tracking and video acquisition. In a navigable environment 1360, a processing module 1372 co-present with the body frame 1370 of an aerial vehicle may be connected to a mechanism for thrust generation 1368. Imaging sensors may detect the optic flow (e.g., at locations 1362, 1363, 1364) and the relative angle or a horizon line with respect to the imaging surface. A method for determining the rotation (and rate of rotation) of the body frame with respect to the environment 1360, may be accomplished by the results of processing or communication aboard the processing module 1372. A method for determining the angle of the horizon may employ a fit to a line defined by a discontinuity of spectral properties (e.g., the power and/or polarization per wavelength) along a boundary, as expected by the ambient light in the sky and the expected reflectance of surface objects in the environment 1360.

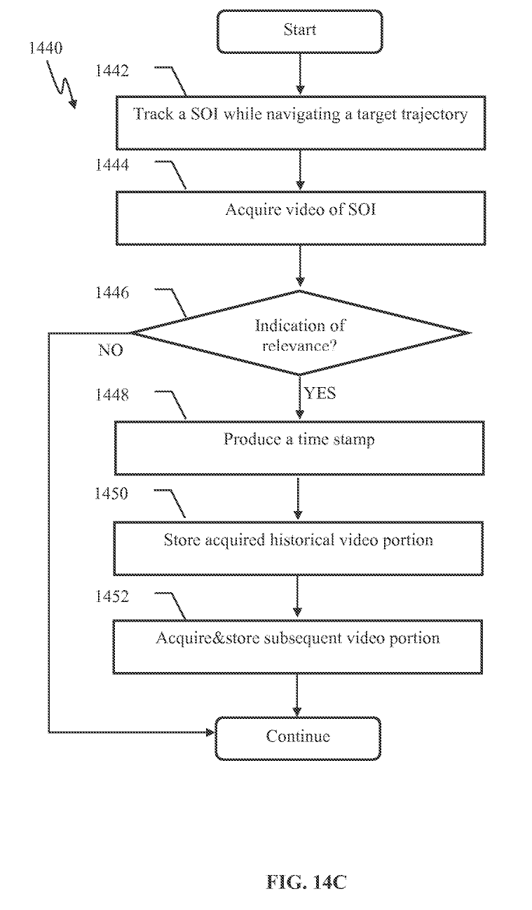

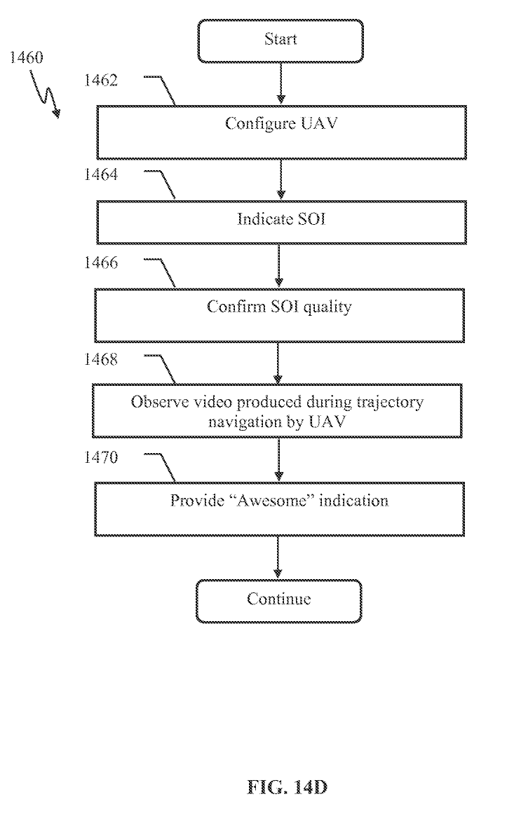

FIGS. 14A-14D illustrate methods 1400, 1410, 1440, 1460 for acquiring video of an SOI from a moving platform and/or operating the platform. The operations of methods 1400, 1410, 1440, 1460 presented below are intended to be illustrative. In some implementations, method 1400, 1410, 1440, 1460 may be accomplished with one or more additional operations not described, and/or without one or more of the operations discussed. Additionally, the order in which the operations of method 1400, 1410, 1440, 1460 are illustrated in FIGS. 14A-14D and described below is not intended to be limiting.

In some implementations, methods 1400, 1410, 1440, 1460 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 1400, 1410, 1440, 1460 in response to instructions stored electronically on an electronic storage medium. The one or more processing devices may include one or more devices configured through hardware, firmware, and/or software to be specifically designed for execution of one or more of the operations of methods 1400, 1410, 1440, 1460.

FIG. 14A is a logical flow diagram illustrating generalized method for trajectory control, in accordance with some implementations. Such a method may be useful when acquiring video from a mobile camera device.

At operation 1402 a state parameter may be determined while navigating a trajectory. In some implementations, the trajectory navigation may comprise navigation of the trajectory 300 and/or 330 by an aerial vehicle described above with respect to FIGS. 3A-3B. The state parameter may comprise one or more vehicle and/or trajectory parameters (e.g., vehicle speed, acceleration, elevation, proximity to SOI and/or obstacles, proximity to state target space boundaries (e.g., 342, 344 in FIG. 3B), and/or other parameters).

At operation 1404 a determination may be made as to whether the state parameter falls within the target area of the state space. In some implementations, the target area of the state space may comprise volume bounded by curves 315, 316 in FIG. 3A and elevation 212 in FIG. 2. In one or more implementations, the target area of the state space may be configured based on occurrence of restricted portions of airspace (e.g., the portions 342, 344 in FIG. 3B).

At operation 1406 the target state space may be populated with one or more trajectory paths. In some implementations, the population of the state space may comprise one or more trajectory types, e.g., oscillating, spiral, random walk, grid, hovering, and/or combination thereof and/or other trajectories. In one or more implementations, populating the state space with one or more paths may be configured based on a timer (e.g., adapt the course when a time interval elapses), platform location (e.g., when passing a landmark, and/or other criteria (e.g., upon completing a revolution around the SOI). The time interval for trajectory adaptation may be selected from the range between 1 second and 30 seconds.

FIG. 14B illustrates a method for producing a time stamp based on an indication of interest, in accordance with some implementations.

At operation 1412 a target trajectory may be navigated. In one or more implementations, the target trajectory navigation may comprise one or more actions described above with respect to FIGS. 1-3C, 7A, 8A, 9B, and/or other actions.

At operation 1414 an indication of interest may be received. In some implementations, the indication of interest may be provided by a user via a smart wearable device (e.g., as shown and described with respect to FIGS. 4A-4D, and/or 5A-5D).

At operation 1416 a time stamp associated with the indication of interest may be produced. In some implementations, the time stamp may comprise an entry in a list configured to indicate a snippet (e.g., 502) in a video stream (e.g., 500 in FIG. 5A). In one or more implementations, the time stamp may be configured to cause recording and/or transmission of a video snippet (e.g., such as described above with respect to FIG. 5E and/or FIG. 14C below).

FIG. 14C illustrates a method for producing a video Snippet based on an indication of relevance, in accordance with some implementations. The method may be employed, for example, by an UAV such as described above with respect to FIGS. 1-3C, 7A, 8A.

At operation 1442 a SOI may be tracked while navigating a target trajectory. In some implementations, the SOI tracking may comprise tracking one or more of a person (e.g., a cyclist 810 in FIG. 8A), a group of people (e.g., shown and described with respect to FIG. 2), an object, and/or other things.

At operation 1444 video of the SOI may be acquired. In some implementations, the acquired video may be stored on board of the UAV and/or streamed to an external storage. In some implementations, e.g., such as described above with respect to FIG. 5E, the acquired video may be stored in as buffer.

At operation 1446 a determination may be made as to whether an indication of relevance has been received. In one or more implementations, the indication of relevance may be provided by the SOI (e.g., the cyclist and/or a person within the group 202 in FIG. 2). The indication of relevance may comprise an “awesome” indication provided using a wearable interface device (e.g., 400, 460, 420, 440 and/or other devices described above with respect to FIGS. 4A-4D). In one or more implementations, the “awesome” indication may be provided to indicate to the controller that the moment in time may have an increased relevance (relative other preceding and/or subsequent moments). By way of an illustration, a mountain biker may use the awesome indication to capture footage of a jump, and/or other actions.

Responsive to a determination at operation 1446 that the indication of relevance had occurred, the method may proceed to operation 1448 wherein a time stamp may be produced. In one or more implementations, the time stamp may comprise an entry in a list configured to denote one or more portions (snippets) of video (e.g., acquired at operation 1444) corresponding to period of relevance, e.g., as described above with respect to FIGS. 5A-5B. In some implementations, the time stamp may be configured to cause storing and/or recording of video corresponding to an interval proximate to occurrence of the time stamp.

In some implementations, the time stamp may be configured to cause recording of a historical video portion and/or subsequent video portion, e.g., the portions 544, 546, respectively, described above with respect to FIG. 5C. At operation 1450 acquired historical video portion may be stored. Duration of the snippet portions 544, 546 may be configured by the user using a computer a browser interface, an application on a portable computing device, and/or a wearable device (e.g., 400, 420, 440, 460), and/or other means.

At operation 1452 subsequent video portion may be acquired and stored. In some implementations, the storing of the historical video portion and/or acquisition of the subsequent portion may be configured based on use of a multiple buffering techniques comprising read and write memory buffers. Time stamp(s) may be utilized in order to index the longer segment and/or to generate shorter clips, via, e.g., a software process. In one or more implementations, the time stamps may be used to modify the video storage process, a subsequent processing stage, by, e.g., enabling a greater compression of regions in the inter-clip intervals (e.g., 518, in FIG. 5B) compared to the in-clip intervals (e.g., 516 in FIG. 5B).

In one or more implementations, snippets associated with user indications of interest may be characterized by video acquisition parameters that may be configured differently compared to the rest of the video stream. By way of an illustration, snippet video may comprise data characterized by one or more of higher frame rate (e.g., for recording bungee or sky-diving jumps, greater bit depth, multiple exposures, increased dynamic range, storing of raw sensor output, and/or other characteristics that may produce larger amount of data (per unit of time) compared to regular video stream portion (e.g., 508, 518, 568 in FIGS. 5A, 5B, 5D). The data rate associated with such enhanced data rate snippets may make it impractical to store and/or transmit the video stream (e.g., 560 in FIG. 5D) in its entirety for the whole sequence.

FIG. 14D illustrates a generalized method for operating a smart wearable device. In one or more implementations, the wearable device may comprise a smart wearable interface device, e.g., 400, 460, 420, 440 and/or other devices described above with respect to FIGS. 4A-4D, configured to interface to a mobile camera apparatus (e.g., UAV such as described above with respect to FIGS. 1-3C, 7A, 8A).

At operation 1462, the wearable device may be used to configure UAV operational parameters. In one or more implementations, the UAV operational parameters may comprise one or more of trajectory parameters such as minimum/maximum range from SOI (e.g., 315, 316 in FIG. 3A, target elevation 212 in FIG. 2, number of circles around the SOI, and/or other parameters, camera video acquisition parameters, (resolution, frame rate, pixel bit depth, and/or other parameters), and/or other settings.

At operation 1464 SOI may be indicated. In some implementations, the SOI indication may comprise a selection of a subject in a video stream provided by the UAV to the wearable device (e.g., a user may touch a portion of the apparatus 440 screen of FIG. 440 in order to point out a person of interest). In some implementations, the SOI selection may comprise an audio command (e.g., “TRACK WHITE DOG”) issued to the wearable device. In some implementations, the SOI selection may comprise the user pressing physical/virtual track button.

At operation 1466 SOI video quality may be confirmed. In some implementations, the SOI quality confirmation may be effectuated based on a user command (touch, audio), and/or absence of user action within a given period (e.g., unless a button is pressed within 30 seconds, the SOI quality is considered satisfactory).

At operation 1466 video produced during trajectory navigation by the UAV may be observed. In some implementations, the video produced during the trajectory navigation by the UAV may be streamed to the wearable device (e.g., 440, 460 in FIGS. 4D, 4B). The user may view the streamed video on the wearable screen. In some implementations, video streamed by the UAV may comprise reduced data rate video (e.g., reduced resolution, and/or frame rate) compares to video that may be stored as snippets (e.g., 502 in FIG. 5A).

At operation 1470 an “awesome” indication may be provided. In some implementations, the user may utilize the wearable smart device (e.g., 460 in FIG. 4B and/or smart bike grip 820 in FIGS. 8A-8B in order to communicate the “awesome” indication to the UAV. The “awesome” indication may comprise “indication of relevance” or “selection of moment,” which could also be triggered by a mechanism like crossing a finish line or scoring a goal, and not limited to a human button press induced by a cognitive state of “interest.” In some implementations, the “awesome” indication may cause the time stamp generation (e.g., described above with respect to FIGS. 14-14C) and/or recording of the video snippet.

Methodology described herein may advantageously allow for real-time control of the robots attention by an external smart agent. The external agent may be better equipped for disregarding distractors, as well as rapidly changing strategies when the circumstances of the environment demand a new cost function (e.g., a switch in the task at hand.) The system may provide means to train up the robot's attention system. In other words, it learns that what it should (automatically) attend to for a particular context, is what the external operator has guided it to in the past.

Exemplary implementations may be useful with a variety of devices including without limitation autonomous and robotic apparatus, and other electromechanical devices requiring attention guidance functionality. Examples of such robotic devises may include one or more of manufacturing robots (e.g., automotive), military, medical (e.g., processing of microscopy, x-ray, ultrasonography, tomography), and/or other robots. Examples of autonomous vehicles may include one or more of rovers, unmanned air vehicles, underwater vehicles, smart appliances (e.g., ROOMBA®), inspection and/or surveillance robots, and/or other vehicles.

Implementations of the principles of the disclosure may be used for entertainment, such as one or more of multi-player games, racing, tag, fetch, personal sports coaching, chasing off crop scavengers, cleaning, dusting, inspection of vehicles and goods, cooking, object retrieval, tidying domestic clutter, removal of defective parts, replacement of worn parts, construction, roof repair, street repair, automotive inspection, automotive maintenance, mechanical debauchery, garden maintenance, fertilizer distribution, weeding, painting, litter removal, food delivery, drink delivery, table wiping, party tricks, and/or other applications.

Implementations of the principles of the disclosure may be applicable to training coordinated operations of automated devices. For example, in applications such as unexploded ordinance/improvised explosive device location and removal, a coordinated search pattern between multiple autonomous learning devices leads to more efficient area coverage. Learning devices may offer the flexibility to handle wider (and dynamic) variety of explosive device encounters. Such learning devices may be trained to identify targets (e.g., enemy vehicles) and deliver similar explosives.

It will be recognized that while certain aspects of the technology are described in terms of a specific sequence of steps of a method, these descriptions are only illustrative of the broader methods of the technology, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the technology disclosed and claimed herein.

While the above detailed description has shown, described, and pointed out novel features of the technology as applied to various implementations, it will be understood that various omissions, substitutions, and changes in the form and details of the device or process illustrated may be made by those skilled in the art without departing from the disclosure. The foregoing description is of the best mode presently contemplated of carrying out the technology. This description is in no way meant to be limiting, but rather should be taken as illustrative of the general principles of the technology. The scope of the technology should be determined with reference to the claims.

What is claimed:

1. A method of context based video acquisition by an autonomous mobile camera apparatus, the method comprising:
acquiring video of a visual scene at a first data rate using the mobile camera apparatus;
producing lower rate video from the video, the lower rate video characterized by a lower data rate compared to the first data rate;
transmitting the lower data rate video via a wireless communications interface;
detecting an indication of interest associated with the video scene; and
in response to detection of the indication, storing the video at the camera apparatus at the first data rate.

2. The method of claim 1, wherein:
the indication of interest is provided via a wearable apparatus of a user based on an occurrence of the context in the visual scene; and
the indication of interest is configured based on an activation of the wearable apparatus by the user.

3. The method of claim 1, wherein:
the visual scene comprises a subject of interest; and
the indication of interest is provided via a remote apparatus configured to determine an occurrence of the context in the visual scene, the context associated with at least one of a location and an action by the subject of interest.

4. The method of claim 1, wherein:
the autonomous mobile camera is configured to follow the subject of interest at a predetermined range; and
the autonomous mobile camera apparatus is configured to automatically adjust orientation of the camera so as to place the subject of interest at a target location within a video frame.

5. A mobile camera apparatus, comprising:
a camera sensor configured to provide video at a full data rate;
a circular memory buffer configured to store a portion of the video at the full data rate, the portion characterized by a first duration;
a nonvolatile storage configured to store video at a reduced data rate for a second duration, the second duration being greater than the first duration;
a communications interface configured to detect indications of interest associated with the video being acquired; and
a processing component configured to produce and store video snippets in response the detected indications of interest by, based on an individual indication of interest:
produce a video snippet, the video snippet characterized by the full resolution, the video snippet production comprising transferring the portion of video at the full resolution from the buffer to the nonvolatile storage; and
store a time tag in a table in the nonvolatile storage, the tag associated with the video snippet;
wherein:
the nonvolatile storage is configured to store video at the full data rate for a third duration, the third duration being greater than the first duration and smaller than the second duration; and
producing the video snippets enables the mobile camera apparatus to obtain video at the full resolution over a time period of at least the second duration.

6. The apparatus of claim 5, wherein:
acquisition of video is configured based on the mobile camera apparatus navigating a path around a subject of interest, the path characterized by a first distance and a second distance from the subject of interest; and
the logic is configured to maintain the mobile camera apparatus within a range between the first distance and the second distance.

7. The apparatus of claim 6, wherein:
when at a first location of the circular path, the camera orientation is characterized by a first direction
when at a second location of the circular path, the camera orientation is characterized by a second direction different from the first direction;
individual ones of the first and the second direction are configured to orient the camera at the subject of interest; and
during navigation of the circular path the logic is configured direct the camera orientation from the first direction to the second direction.

8. The apparatus of claim 7, wherein:
the video comprises a plurality of frames characterized by frame dimension; and
the transition of the camera orientation from the first direction to the second direction is characterized by a plurality of angular adjustments, individual ones of the plurality of angular adjustments configured to cause displacement of the subject of interest location between two consecutive frames of the plurality of frames that is not greater than 5% of the frame dimension.

9. The apparatus of claim 5, wherein:
the indication of interest is provided via a remote apparatus configured to determine an occurrence of the context associated with the subject of interest, the context determination configured based on at least one of a location and an action by the subject of interest.

10. The apparatus of claim 9, wherein:
the remote apparatus comprises a wearable device disposed on the subject of interest, the device comprising a user interface element; and
the indication of interest is being communicated by the a wearable device responsive to activation of the element by the subject of interest.

11. The apparatus of claim 10, wherein:
the apparatus is configured to communicate video at the reduced data rate to the wearable device.

12. The apparatus of claim 10, wherein:
the video snippet is characterized by a pre-event duration and a post-event duration, a combination of the pre-event duration and the post-event duration being smaller than the first duration;
the pre-event duration corresponding to video acquired prior to the indication;
the post-event duration corresponding to video acquired subsequent to the indication; and
an amount of time included in the pre-event duration and an amount of time included in the post-event duration are being configured via the wearable device.

13. The apparatus of claim 9, wherein:
the remote apparatus comprises a computerized device configured to determine location of the subject of interest and to communicate the indication based on the location being within a given bound.

14. The apparatus of claim 5, wherein the logic is configured to, based on detection of an object along the trajectory, to modify the trajectory so as to avoid a collision with the object while maintaining the platform within the range.

15. The apparatus of claim 5, wherein:
the trajectory is characterized by a first range and a second range from a subject of interest; and
during the trajectory navigation the controller is configured to:
navigate the platform along a path of a plurality of paths, individual ones of the plurality of paths being maintained within an extent no closer than the first range to the subject of interest and no farther than the second range from the subject of interest; and
select another path of the plurality of paths based on a path adaptation parameter.

16. The apparatus of claim 15, wherein the path adaptation parameter comprises one or more of a time interval and location of the apparatus.

17. The apparatus of claim 5, wherein:
the full data rate exceeds the reduced data rate by at least a factor of four; and
the indication is configured to cause video acquisition at the full data rate at least during a segment of the portion subsequent to the indication.

18. A mobile video acquisition apparatus, comprising:
a camera component to provide video of a user;
a nonvolatile storage capable to store the video for a first duration;
a communications interface configured to detect an indication of interest of a plurality of indication of interest associated with the video being provided; and
a logic configured to produce times stamps in response to detected indications of interest by, based on an individual indication of interest, produce a time stamp;
wherein:
the individual indication of interest is produced by a user wearable device based on an action of the user, the wearable device disposed remote from the video acquisition apparatus and in data communication with the video acquisition apparatus;
the individual time stamp enables automatic access to a respective video snippet of the video stored on the nonvolatile storage corresponding to the individual indication of interest;
the respective snippet being of a snippet duration; and
a combined duration of snippet durations for video snippets corresponding to the detected indications of interest is smaller than the first duration.

19. The mobile video apparatus of claim 18, wherein all of the video snippets have the same snippet duration.

20. The mobile video apparatus of claim 18, wherein at least one of the video snippets has a snippet duration that is different from a snippet duration of another one of the video snippets.
